(19) United States
(12) Patent Application Publication
(10) Pub. No.: US 2013/0088544 A1
(43) Pub. Date: Apr. 11, 2013

(54) WIPING METHOD FOR INKJET RECORDING HEAD

(71) Applicant: Canon Kabushiki Kaisha, Tokyo (JP)

(72) Inventor: Shin Ishimatsu, Fuchu-shi (JP)

(73) Assignee: CANON KABUSHIKI KAISHA, Tokyo (JP)

(21) Appl. No.: 13/692,826

(22) Filed: Dec. 3, 2012

Related U.S. Application Data
(63) Continuation of application No. 12/174,556, filed on Jul. 16, 2008.

(30) Foreign Application Priority Data
Jul. 17, 2007 (JP) 2007-185870

(51) Int. Cl. B41J 2/165

(52) U.S. Cl. CPC B41J 2/16535
USPC 347/28; 347/33

(57) ABSTRACT

An inkjet recording apparatus to record an image by discharging ink includes a recording head, a processing-liquid transferring unit, a wiper, and a control unit. The recording head includes, at a discharge surface, a first discharge-port row configured to discharge a first ink and a second discharge-port row configured to discharge a second ink. The processing-liquid transferring unit provides processing liquid. The wiper wipes the discharge surface, wherein the wiper includes a first wiper segment positioned to wipe the first discharge-port row and a second wiper segment positioned to wipe the second discharge-port row. The control unit moves the wiper into and out of contact force engagement with the processing-liquid transferring unit, wherein the first wiper segment receives a quantity of processing liquid from the processing-liquid transferring unit that is greater than a quantity of processing liquid received by the second wiper segment from the processing-liquid transferring unit.

### CROSS REFERENCE TO RELATED APPLICATIONS

This application is a continuation of application Ser. No. 12/174,556, filed on Jul. 16, 2008, which claims the benefit of Japanese Patent Application No. 2007-185870 filed Jul. 17, 2007, which are hereby incorporated by reference herein in their entirety.

### BACKGROUND OF THE INVENTION

1. Field of the Invention

The present invention relates to a wiping method for wiping with a wiper an inkjet recording head that records an image by discharging ink.

2. Description of the Related Art

Recording apparatuses including recording heads for recording images on recording media on the basis of image information are generally used as printers, copy machines, facsimile machines, etc. An example of a recording apparatus is an inkjet recording apparatus that performs a recording operation by discharging ink from a discharge-port surface of a recording head. In the inkjet recording apparatus, ink contained in pressure chambers is rapidly pressurized so that the ink is discharged toward a recording medium, such as a sheet of paper, through discharge ports. Thus, an image is recorded. The ink can be pressurized by using, for example, exothermic elements or piezoelectric elements. In the recording head (inkjet recording head) of the inkjet recording apparatus, viscosity of the ink increases as the ink solvent evaporates, and accordingly the ink adheres to the discharge-port surface, in which small discharge ports are formed, and solidifies on the discharge-port surface. If the ink with the increased viscosity adheres to the discharge-port surface in areas near the discharge ports, a discharge failure may occur. To prevent the discharge failure, a wiping unit is provided to wipe the discharge-port surface with a wiper having an elastic member made of elastomer or the like. The process of wiping and cleaning the discharge-port surface is repeated at a predetermined time interval or each time a recovery process is performed.

There is an increasing demand for recording apparatuses capable of recording images with high definitions, for example, images with high coloring properties on sheets of paper. Many kinds of ink used to satisfy such a demand are produced using ink solvent having a high evaporation rate, and therefore easily solidify and strongly adhere to the discharge-port surface. Ink components that are strongly bonded to the discharge-port surface may be removed by a method discussed in U.S. Pat. No. 5,905,514. According to this method, the discharge-port surface is wiped with a specific processing liquid (cleaning liquid) applied thereto.

In the case where a plurality of kinds of ink is used to record high-definition images, the adhesion force largely varies depending on the kind of the ink. Therefore, the amount of processing liquid can be increased for the ink with strong adhesion force. However, in such a case, a large amount of processing liquid is consumed. In the wiping process, the processing liquid becomes mixed with the ink contained in the discharge ports. Thus, the amount of mixed ink is increased along with the amount of processing liquid used in the wiping process. To remove the mixed ink, the ink is sucked out of the discharge ports. Therefore, the ink consumption increases as the amount of processing liquid used in the wiping process is increased. For some kinds of ink, the effect of the processing liquid cannot be enhanced simply by increasing the amount of processing liquid used in the wiping process. In addition, when processing liquid with high detergency is used to remove ink with strong adhesion force, there is a risk that the discharge-port surface will be damaged in an area where ink with weak adhesion force is bonded. In addition, some kinds of processing liquid cause other kinds of problems, such as deposition of ink components, depending on the kind of ink even if the ink bonded to the discharge-port surface can be effectively removed. The number of times the discharge-port surface is wiped can be increased for the ink with strong adhesion force. However, in such a case, the throughput of the recording operation is reduced.

According to U.S. Pat. No. 5,905,514, glycerin is used as the processing liquid to be applied to the discharge-port surface or the wiper. Glycerin has a property of effectively removing the ink components bonded to the discharge-port surface and does not easily evaporate. Therefore, glycerin is favorable as the processing liquid (cleaning liquid). However, the viscosity of glycerin is highly dependent on temperature, and the amount of glycerin applied to the discharge-port surface or the wiper varies depending on the ambient temperature. More specifically, when the ambient temperature is low, the viscosity is increased and the amount of glycerin applied is reduced. When the ambient temperature is high, the viscosity is reduced and the amount of glycerin applied is increased. If the amount of processing liquid is too small, the ink components bonded to the discharge-port surface cannot be sufficiently re-dissolved. Thus, the ink components cannot be sufficiently removed and the recording quality is affected. This can be avoided by increasing the number of times the wiping process is performed. However, in such a case, throughput of the recording operation is reduced. If the amount of processing liquid is too large, the processing liquid is consumed more than necessary and the recording costs will be increased. In the wiping process, the processing liquid becomes mixed with the ink contained in the discharge ports. Thus, the amount of mixed ink is increased along with the amount of processing liquid used in the wiping process. To remove the mixed ink, the ink is sucked out of the discharge ports. Therefore, the ink consumption increases as the amount of processing liquid used in the wiping process is increased. As a result, high costs are incurred.

An example of a method for solving the above-mentioned problem is a method in which the amount of processing liquid used in the wiping process is changed in accordance with the ambient temperature. However, this method is not effective if a plurality of kinds of ink are used and the adhesion tendency of ink components with respect to the temperature differs for each kind of ink. When the ambient temperature is low, the speed at which the ink dries on the discharge-port surface is not high. In addition, the viscosity of the ink itself increases and the fluidity thereof on the discharge-port surface decreases. In addition, the fluidity of the processing liquid also decreases. Due to the reduction in fluidity of the ink and the processing liquid, the ink and the processing liquid are suppressed from being mixed with each other in the wiping process. As a result, the wiping performance is degraded. When the ambient temperature is high, the fluidity of the ink and that of the processing liquid are high. Therefore, the ink and the processing liquid can be appropriately mixed with each other. However, the speed at which the ink dries on the discharge-port surface is high, and therefore the dried ink components cannot be easily re-dissolved. This may lead to wiping failure.

### SUMMARY OF THE INVENTION

The present invention provides a wiping method for an inkjet recording head by which processing liquid can be adequately applied to discharge-port rows in accordance with differences in ink adhesion force and by which the discharge-port rows corresponding to respective kinds of ink can be efficiently wiped.

According to an aspect of the present invention, a wiping method for an inkjet recording head has a discharge-port surface and a plurality of ink-discharge-port rows. The method includes applying processing liquid to the discharge-port surface or a wiper, an amount of the processing liquid applied to the discharge-port surface or the wiper being different for each of the ink-discharge-port rows, and wiping the discharge-port surface along with the processing liquid with the wiper.

Further features of the present invention will become apparent from the following description of exemplary embodiments with reference to the attached drawings.

### BRIEF DESCRIPTION OF THE DRAWINGS

FIG. 1 is a perspective view of an inkjet recording apparatus according to a first embodiment.

FIGS. 2A to 2C are diagrams illustrating the movement of a wiper according to the first embodiment.

FIG. 3 is a perspective view of an inkjet recording head according to the first embodiment seen from the side of a discharge-port surface.

FIGS. 4A to 4F are diagrams illustrating the movement of a wiper according to a second embodiment.

FIG. 5 is a perspective view of the wiper according to the second embodiment.

FIGS. 6A and 6B are side views illustrating the movement of the wiper shown in FIG. 5.

FIG. 7 is a perspective view illustrating a first modification of the wiper according to the second embodiment.

FIG. 8 is a perspective view illustrating a second modification of the wiper according to the second embodiment.

FIG. 9 is a perspective view of a wiper according to a third embodiment.

FIG. 10 is a side view illustrating the movement of processing liquid in a process of wiping the discharge-port surface by bringing an end portion of the wiper into contact with the discharge-port surface.

FIG. 11 is a side view illustrating the movement of the processing liquid in a process of wiping the discharge-port surface by bringing the wiper into contact with the discharge-port surface.

FIG. 12 is a perspective view illustrating the structure of a wiper having a portion with low surface roughness and a portion with high surface roughness.

FIGS. 13A and 13B are side views illustrating the movements of the wiper and the processing liquid.

FIG. 14 is a perspective view illustrating the major part of a wiper according to a fourth embodiment.

FIGS. 15A and 15B are side views illustrating the process in which the processing liquid is transferred from a processing-liquid transferring unit to the wiper.

FIGS. 16A and 16B are side views illustrating the movement of a wiper segment when the wiper segment is brought into contact with the processing-liquid transferring unit and the discharge-port surface.

FIGS. 17A and 17B are sectional views of a wiper segment in which transverse cut portions are formed instead of transverse grooves.

FIGS. 18A to 18C are side views illustrating an operation in which a wiper is brought into contact with the processing-liquid transferring unit.

FIG. 19 is a perspective view of a wiper including wiper segments attached at different angles.

FIG. 20 is a perspective view of an inkjet recording apparatus according to a sixth embodiment.

FIGS. 21A to 21C are diagrams illustrating the movement of a wiper according to the sixth embodiment.

FIG. 22 is a perspective view of a recovery unit according to a seventh embodiment.

FIGS. 23A to 23F are diagrams illustrating the movement of a wiper according to the seventh embodiment.

FIG. 24 is a perspective view of a processing-liquid transferring unit according to the seventh embodiment seen from the side at which the wiper comes into contact with a processing-liquid transferring unit.

FIG. 25 is a perspective view illustrating the state in which the processing liquid is transferred to the wiper according to the seventh embodiment.

FIG. 26 is a perspective view illustrating a modification of the recovery unit according to the seventh embodiment.

FIG. 27 is a perspective view of a recovery unit according to an eighth embodiment.

FIG. 28 is a perspective view of a wiper according to a ninth embodiment.

FIG. 29 is a perspective view of a processing-liquid transferring unit according to a modification of the ninth embodiment.

FIG. 30 is a perspective view of a wiper according to a tenth embodiment of the present embodiment.

FIG. 31 is a perspective view of an inkjet recording apparatus according to an eleventh embodiment.

FIGS. 32A to 32C are diagrams illustrating the movement of a wiper according to the eleventh embodiment.

FIG. 33 is a perspective view of a recovery unit according to a twelfth embodiment.

FIGS. 34A to 34F are diagrams illustrating the operation according to the twelfth embodiment in the case in which the movement of the wiper is restricted.

FIGS. 35A to 35F are diagrams illustrating the operation according to the twelfth embodiment in the case in which the movement of the wiper is not restricted.

FIG. 36 is a perspective view of a recovery unit included in an inkjet recording apparatus according to a fourteenth embodiment.

### DESCRIPTION OF THE EMBODIMENTS

### First Embodiment

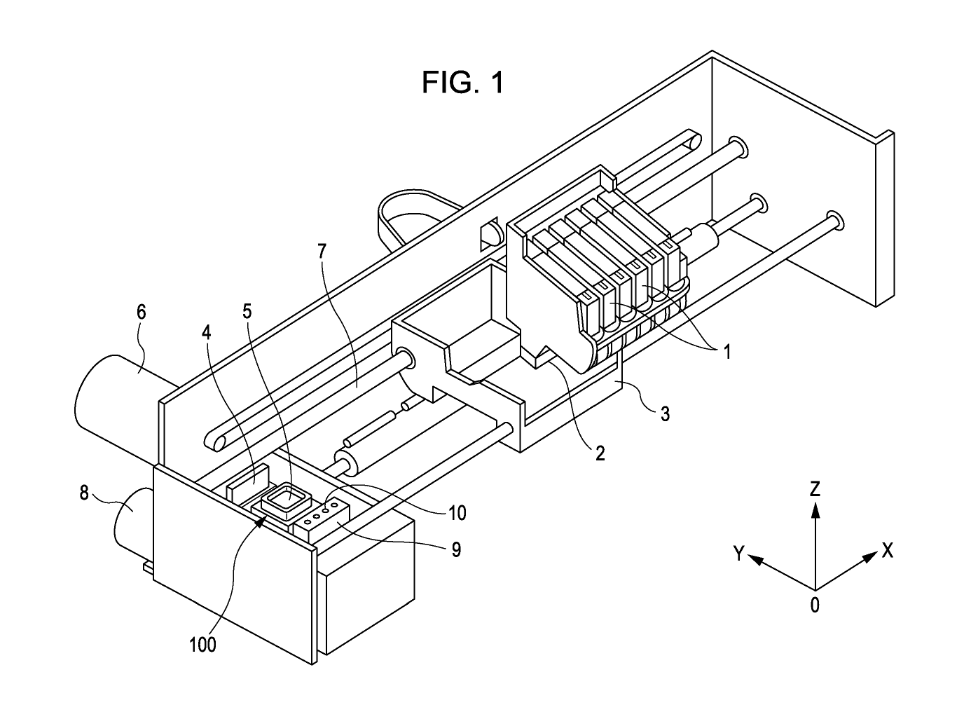

FIG. 1 is a perspective view of an inkjet recording apparatus according to a first embodiment. Referring to FIG. 1, an inkjet recording head 1 has a discharge-port surface 2 in which a plurality of discharge-port rows are formed in a predetermined pattern. The inkjet recording head 1 is mounted on a carriage 3. The carriage 3, on which the inkjet recording head 1 is mounted, is reciprocated in the X direction by a carriage motor 6 (main scanning). The carriage 3 that reciprocates is supported and guided by a guide shaft 7. A recovery unit 100 for maintaining and recovering the ink discharge performance of the inkjet recording head 1 is disposed within a movable range of the carriage 3 at a position outside a recording area.

The recovery unit 100 includes a wiper 4 for wiping the discharge-port surface 2 of the inkjet recording head 1, a cap 5 that can be tightly attached to the discharge-port surface 2 so as to cover the discharge-port rows, and a recovery-unit motor 8 for moving the wiper 4 in a wiping direction (Y direction). The recovery unit 100 also includes a processing-liquid ejecting unit 9 having ejection ports 10 from which processing liquid is ejected such that the processing liquid adheres to the discharge-port surface 2. The processing-liquid ejecting unit 9 functions as a processing-liquid applying unit. The orientations of the ejection ports 10 formed in the processing-liquid ejecting unit 9 are adjusted such that the processing liquid adheres to each of the discharge-port rows on the discharge-port surface 2. The processing liquid is supplied from a processing-liquid container (processing liquid tank) to the processing-liquid ejecting unit 9 in response to the operation of the recovery-unit motor 8, and is ejected from the ejection ports 10.

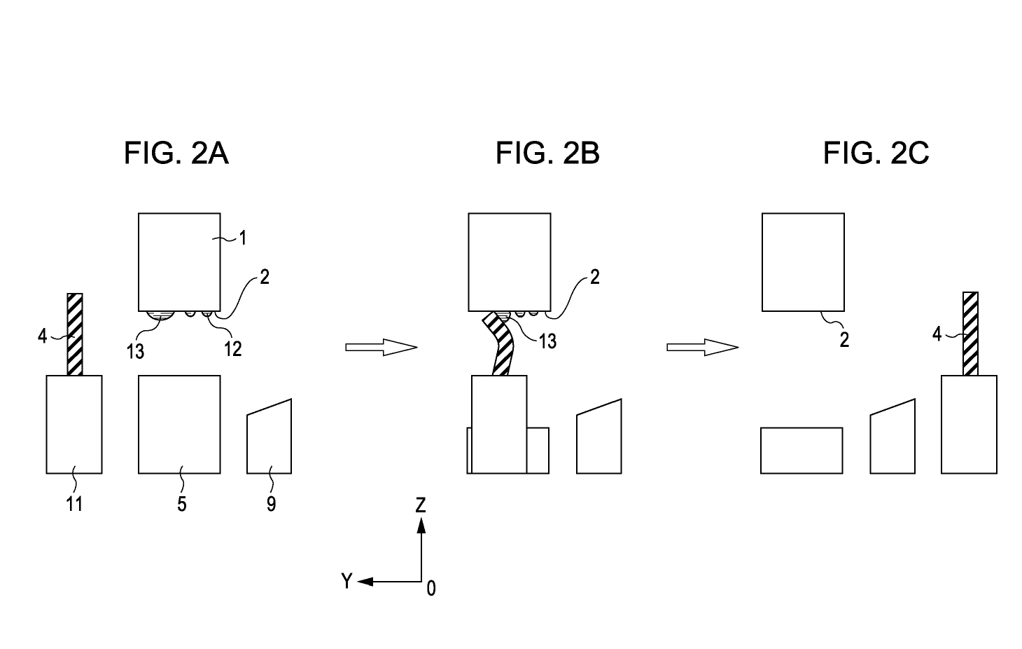

FIGS. 2A to 2C illustrate the movement of the wiper 4 according to the first embodiment. FIG. 2A shows the standby state, FIG. 2B shows the state in which the discharge-port surface 2 is being wiped, and FIG. 2C shows the state after the discharge-port surface 2 is wiped. FIGS. 2A to 2C are sectional views of FIG. 1 taken along the YZ plane. In FIGS. 2A to 2C, the wiper 4 is held by a wiper-holding unit 11. The wiper-holding unit 11 is gate-shaped so that the cap 5 and the processing-liquid ejecting unit 9 can pass through the wiper-holding unit 11 when the wiper-holding unit 11 is moved as shown in FIGS. 2B and 2C. Reference numeral 12 denotes ink droplets on the discharge-port surface 2, and reference numeral 13 denotes the processing liquid ejected from the processing-liquid ejecting unit 9 and applied to the discharge-port surface 2. The height of the wiper 4 is adjusted such that the wiper 4 comes into contact with the discharge-port surface 2 in a predetermined manner. A process of wiping the discharge-port surface 2 (wiping process) is performed by moving the wiper 4 in the Y direction while the processing liquid is applied to the discharge-port surface 2. In this process, if the ink droplets 12 are present on the discharge-port surface 2, the ink and the processing liquid are mixed with each other on the discharge-port surface 2.

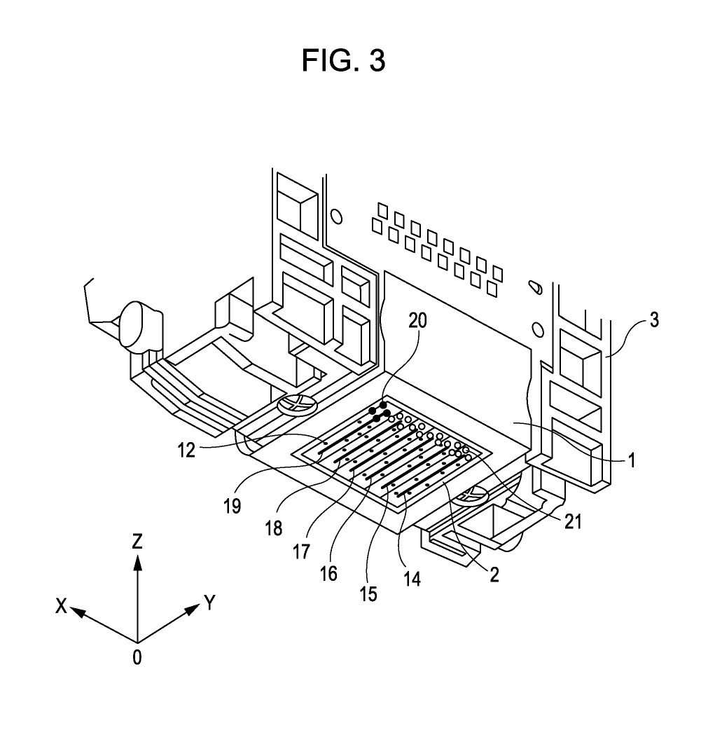

FIG. 3 is a perspective view of the inkjet recording head 1 according to the first embodiment seen from the side of the discharge-port surface 2. In FIG. 3, the discharge-port surface 2 has a plurality of discharge-port rows (six in this embodiment) for discharging different kinds of ink. Each of the discharge-port rows includes a plurality of discharge ports arranged at a predetermined pitch. The wiping direction of the wiper 4 is set to the Y direction, which corresponds to the direction in which the discharge-port rows extend, that is, the direction in which the discharge ports are arranged. The discharge-port rows are arranged parallel with each other in the direction (X direction) that crosses the wiping direction of the wiper 4. The discharge-port rows include a discharge-port row D 14 having a plurality of discharge ports from which cyan ink is discharged; a discharge-port row E 15 having a plurality of discharge ports from which magenta ink is discharged; a discharge-port row F 16 having a plurality of discharge ports from which yellow ink is discharged; a discharge-port row G 17 having a plurality of discharge ports from which black ink is discharged; a discharge-port row H 18 having a plurality of discharge ports from which green ink is discharged; and a discharge-port row J 19 having a plurality of discharge ports from which red ink is discharged.

The six discharge-port rows 14 to 19 are arranged parallel with each other on the discharge-port surface 2 in a direction crossing the wiping direction (Y direction) of the wiper 4. Processing liquid K is applied to the discharge-port surface 2 in a region around the discharge-port row J 19 for the red ink. Processing liquid L is applied to the discharge-port surface 2 in regions around the other discharge-port rows (the discharge-port row D 14 for the cyan ink to the discharge-port row H 18 for the green ink). The processing liquid K and the processing liquid L are applied to the discharge-port surface 2 by being ejected from the ejection ports 10 in the processing-liquid ejecting unit 9 that functions as the processing-liquid applying unit.

The inkjet recording head 1 mounted on the carriage 3 is moved by the carriage motor 6 to a position where the inkjet recording head 1 faces the cap 5 in the recovery unit 100. Thus, the state shown in FIG. 2A is established. Then, the processing liquid is ejected from the ejection ports 10 in the processing-liquid ejecting unit 9 toward the discharge-port rows 14 to 19 on the discharge-port surface 2. An amount of the processing liquid to be ejected is set for each of the discharge-port rows 14 to 19. Thus, a preset amount of processing liquid is applied to each of the discharge-port rows. Then, as shown in FIG. 2B, the wiper 4 is moved in the Y direction so that the discharge-port surface 2 is wiped by the wiper 4. At this time, as shown in FIG. 3, the amount of the processing liquid applied to the discharge-port rows 14 to 19 is adjusted for each of the discharge-port rows 14 to 19. Thus, the discharge-port surface 2 can be wiped using the optimum amount of processing liquid for each of the discharge-port rows 14 to 19 in accordance with the characteristics of the ink discharged from the discharge-port rows 14 to 19.

As an example, liquid glycerin (100%) was used as the processing liquid to be applied to the discharge-port rows 14 to 19 from which six kinds of ink are discharged. Only the ejection port 10 used to eject the processing liquid toward the discharge-port row J 19 was designed to have a large diameter, and the other ejection ports 10 used to eject the processing liquid toward the other discharge-port rows 14 to 18 were designed to have a small diameter. The wiping process was performed while 0.4 mg of the processing liquid was applied to the discharge-port row J 19 and 0.1 mg of the processing liquid was applied to each of the other discharge-port rows. The recording operation was performed using each kind of ink at DUTY 25% (images were recorded on twenty A4-size sheets while performing the wiping process once every time a single sheet was recorded on). As a result, satisfactory recording results were obtained. For comparison, a similar recording operation was performed without changing the diameter of the ejection ports, that is, while 0.1 mg of the processing liquid was applied to the discharge-port rows J 19, similar to the other discharge-port rows, in the wiping process. In this case, recording defects, such as uneven density distribution, occurred in only the region recorded by red ink (discharge-port row J).

As for a method for ejecting the processing liquid, a pressurizing motor included in the recording apparatus was operated to apply pressure to the processing-liquid ejecting unit 9, so that the processing liquid 13 was sprayed from the ejection ports 10 toward the discharge-port surface 2 for a predetermined time interval. The amount of the processing liquid 13 to be ejected was adjusted by adjusting the size of the ejection ports 10. However, the present embodiment is not limited to the above-described method in which the size of the processing-liquid ejection ports is changed. For example, the ejection pressure at which the processing liquid 13 is ejected can be adjusted for each discharge-port row, or the number of times the processing liquid 13 is ejected can be adjusted for each discharge-port row. In addition, the method for applying the processing liquid 13 to the discharge-port surface 2 is not limited to the method in which the processing liquid 13 is sprayed by applying pressure thereto. For example, the processing liquid 13 can also be transferred onto the discharge-port surface 2.

### Second Embodiment

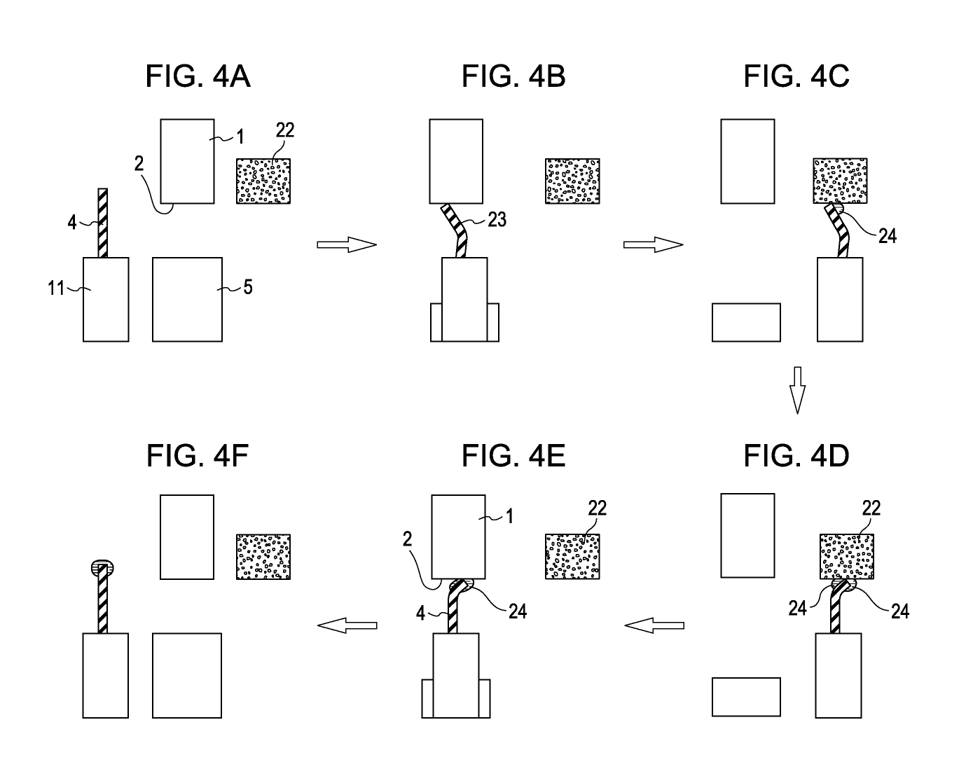

FIGS. 4A to 4F are diagrams illustrating the movement of a wiper 4 according to a second embodiment. In the present embodiment, different from the first embodiment in which the processing liquid is directly applied to the discharge-port surface 2, first, the processing liquid is applied to the wiper 4. Then, the wiping process is performed by bringing the wiper 4 to which the processing liquid is applied into contact with the discharge-port surface 2. FIGS. 4A to 4F are sectional views of FIG. 1 taken along the YZ plane. An inkjet recording apparatus according to the present embodiment is similar to the inkjet recording apparatus shown in FIG. 1 except the processing-liquid ejecting unit 9 is replaced by a processing-liquid transferring unit 22. The processing-liquid transferring unit 22 also functions as the processing-liquid applying unit. A recording head 1 of the present embodiment is similar to the recording head according to the first embodiment shown in FIG. 3. FIG. 4A shows the state in which the wiper 4 is in the standby state. FIG. 4B shows the state in which the wiper 4 passes by the discharge-port surface 2. FIG. 4C shows the state in which the wiper 4 comes into contact with the processing-liquid transferring unit 22 and the processing liquid is transferred to the wiper 4. FIG. 4D shows the state in which the wiper 4 starts moving in the opposite direction while the wiper 4 is in contact with the processing-liquid transferring unit 22. FIG. 4E shows the state in which the discharge-port surface 2 is wiped by the wiper 4 which is being moved in the opposite direction and on which the processing liquid is transferred. FIG. 4F shows the state in which the wiper 4 is returned to the standby position after the discharge-port surface 2 is wiped by the wiper 4 using the processing liquid.

As shown in FIG. 4A, the processing-liquid transferring unit 22 is disposed at a certain position opposite to the standby position of the wiper 4 across the recording head 1. The processing-liquid transferring unit 22 functions as the processing-liquid applying unit, and the wiper 4 comes into contact with the processing-liquid transferring unit 22 so that the processing liquid is applied to the wiper 4. The processing-liquid transferring unit 22 includes, for example, a porous body capable of retaining the processing liquid. The wiper 4 comes into contact with the discharge-port surface 2 once, as shown in FIGS. 4A and 4B, and then comes into contact with the processing-liquid transferring unit 22. The wiper 4 is bent when the wiper 4 comes into contact with the processing-liquid transferring unit 22. Thus, as shown in FIG. 4C, the processing liquid 24 is transferred onto a surface 23 of the wiper 4. Then, the wiper 4 starts moving in the opposite direction while the wiper 4 is in contact with the processing-liquid transferring unit 22 and the wiper 4 is bent in the opposite direction. Thus, as shown in FIG. 4D, the processing liquid 24 is applied to both surfaces of the wiper 4. The wiper 4 moved in the opposite direction continuously retains the processing liquid 24 and comes into contact with the discharge-port surface 2. Then, as shown in FIG. 4E, the discharge-port surface 2 is wiped by the wiper 4 with the processing liquid 24 interposed between the discharge-port surface 2 and the wiper 4. Then, the wiper 4 returns to the standby position, as shown in FIG. 4F.

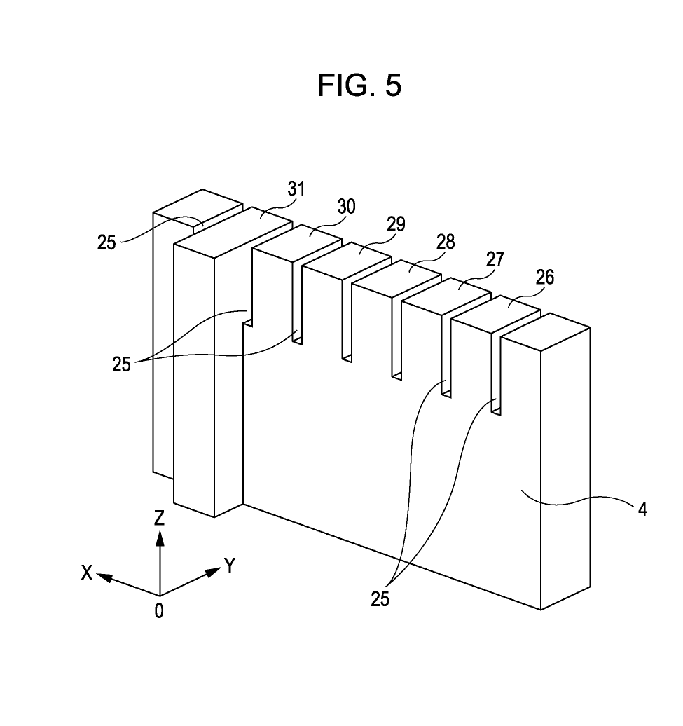

FIG. 5 is a perspective view of the wiper 4 according to the second embodiment. FIG. 5 shows the state in which the wiper 4 is removed from the wiper-holding unit 11. Referring to FIG. 5, the wiper 4 has slits 25 that divide a portion of the wiper 4 that comes into contact with the discharge-port surface 2 into segments corresponding to the discharge-port rows 14 to 19. Thus, the slits 25 serve to define wiper segments 26 to 31 in the wiper 4. More specifically, a wiper segment D 26 corresponding to the discharge-port row D 14, a wiper segment E 27 corresponding to the discharge-port row E 15, a wiper segment F 28 corresponding to the discharge-port row F 16, a wiper segment G 29 corresponding to the discharge-port row G 17, a wiper segment H 30 corresponding to the discharge-port row H 18, and a wiper segment J 31 corresponding to the discharge-port row J 19 are provided in that order from the right in FIG. 5. The wiper segment J 31 is relatively thick and therefore has a relatively high rigidity. The other segments G 26 to H 29 are relatively thin and therefore have a relatively low rigidity. When the wiper 4 comes into contact with the processing-liquid transferring unit 22, the wiper segment J 31, which is relatively thick and rigid, receives a larger (stronger) contact force from the processing-liquid transferring unit 22 than that applied to the other wiper segments. Therefore, when the wiper 4 comes into contact with the discharge-port surface 2, the wiper segment J 31 wipes the discharge-port surface 2 while applying a larger amount of processing liquid to the discharge-port surface 2 compared to the other wiper segments.

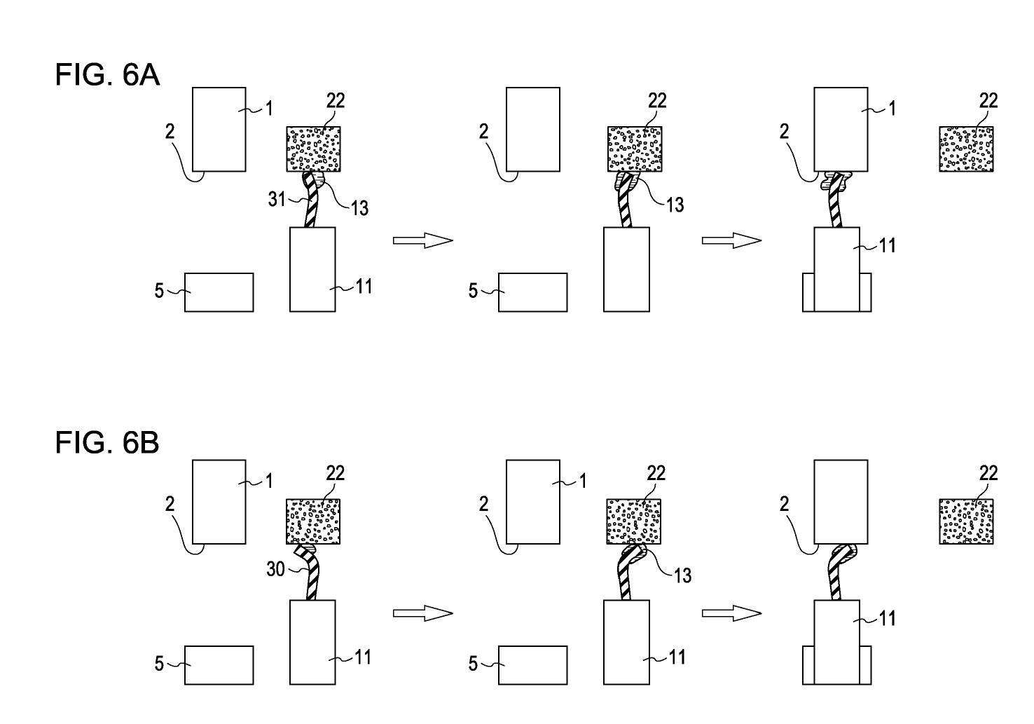

FIGS. 6A and 6B are side views illustrating the movement of the wiper 4 shown in FIG. 5. FIG. 6A shows the movement of the wiper segment J 31, which is relatively thick, and FIG. 6B shows the movement of the other wiper segments, which are relatively thin (the wiper segment H 30 is shown as a representative). The wiper segments other than the wiper segment J 31 are thinner than the wiper segment J 31, and are relatively soft. Therefore, force applied by the wiper segments other than the wiper segment J 31 to remove the processing liquid from the processing-liquid transferring unit 22 is relatively weak. As a result, an amount of processing liquid applied to each of the wiper segments other than the wiper segment J 31 is smaller than that applied to the wiper segment J 31. Therefore, when the wiper 4 comes into contact with the discharge-port surface 2, the wiper segments other than the wiper segment J 31 wipe the discharge-port surface 2 while applying a smaller amount of processing liquid to the discharge-port surface 2 compared to the amount of processing liquid applied by the wiper segment J 31.

When the wiper 4 comes into contact with the inkjet recording head 1 or the processing-liquid transferring unit 22, as shown in FIG. 6B, the wiper segments thinner than the wiper segment J 31 (e.g., the wiper segment H 30) are relatively largely bent. In comparison, as shown in FIG. 6A, the amount of bending (curvature) of the wiper segment J 31, which is relatively thick, is relatively small. As an example, a wiper was prepared in which the thickness of the wiper segment J 31 that corresponds to the discharge-port row J was set to 1 mm in the Y direction in FIG. 5 and the thickness of the other wiper segments was set to 0.75 mm. The processing-liquid transferring unit contained glycerin 100%. Similar to the first embodiment, each kind of ink was guided to the corresponding discharge-port row and the recording operation was performed at DUTY 25% by recording images on twenty A4-size sheets while performing the wiping process once every time a single sheet was recorded on. As a result, satisfactory recording results were obtained. The amount of processing liquid transferred (applied) to the wiper segment J 31 was 0.4 mg for each cycle of the wiping process. The amount of processing liquid transferred (applied) to each of the other wiper segments was 0.1 mg for each cycle of the wiping process. For comparison, a wiper having a wiper segment J with a thickness of 1 mm, similar to the other wiper segments, was prepared. The amount of processing liquid transferred (applied) to this wiper segment J was 0.1 mg, similar to the other wiper segments. In this case, recording defects occurred in a region where an image was recorded by red ink discharged from the discharge-port row J, which correspond to the wiper segment J.

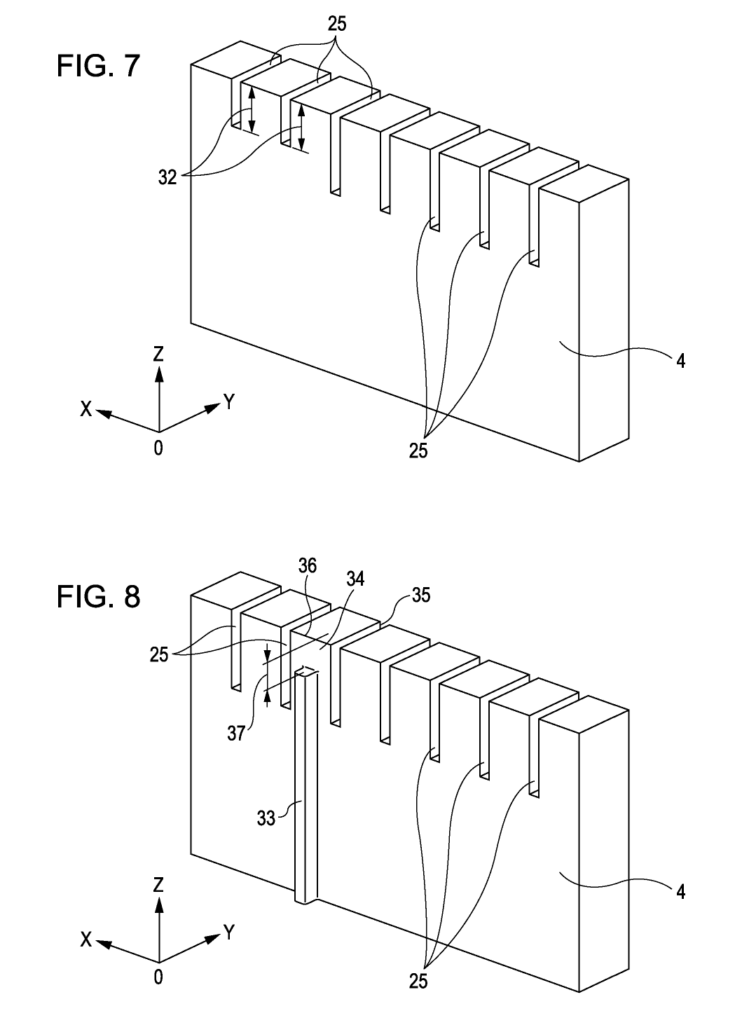

In the present embodiment, the thickness of a segment of the wiper corresponding to a specific discharge-port row is changed to change the rigidity of the segment. However, the present invention is not limited to this, and the rigidity can also be changed by other methods. For example, as shown in FIG. 7, the depth of slits 25 can be varied instead of changing the thickness. In the structure shown in FIG. 7, a depth 32 of the slits 25 on either side of the wiper segment whose rigidity is to be increased is set to be smaller than the depth of the slits 25 on the sides of the other wiper segments. Alternatively, as shown in FIG. 8, a rib 33 can be formed on the wiper segment whose rigidity is to be increased. In the structure including the rib 33 shown in FIG. 8, the rigidity of the wiper segment having the rib 33 can be adjusted by adjusting the width, number, length, shape, etc., of the rib 33. In the case where the rib 33 is formed on the wiper 4, the inkjet recording head 1 can be moved so that a surface 34 on which the rib 33 is formed does not come into contact with the discharge-port surface 2. Alternatively, the timing at which the wiper 4 is moved can be adjusted so that the surface 34 does not come into contact with the discharge-port surface 2. Alternatively, a surface 35 that is free from the rib 33 can be brought into contact with the discharge-port surface 2. Alternatively, the wiper 4 can be configured such that only an end portion 36 of the wiper 4 comes into contact with the discharge-port surface 2 and a flat surface can be formed so as to extend from the end portion 36 by a certain distance 37 so that the rib 33 does not come into contact with the discharge-port surface 2.

### Third Embodiment

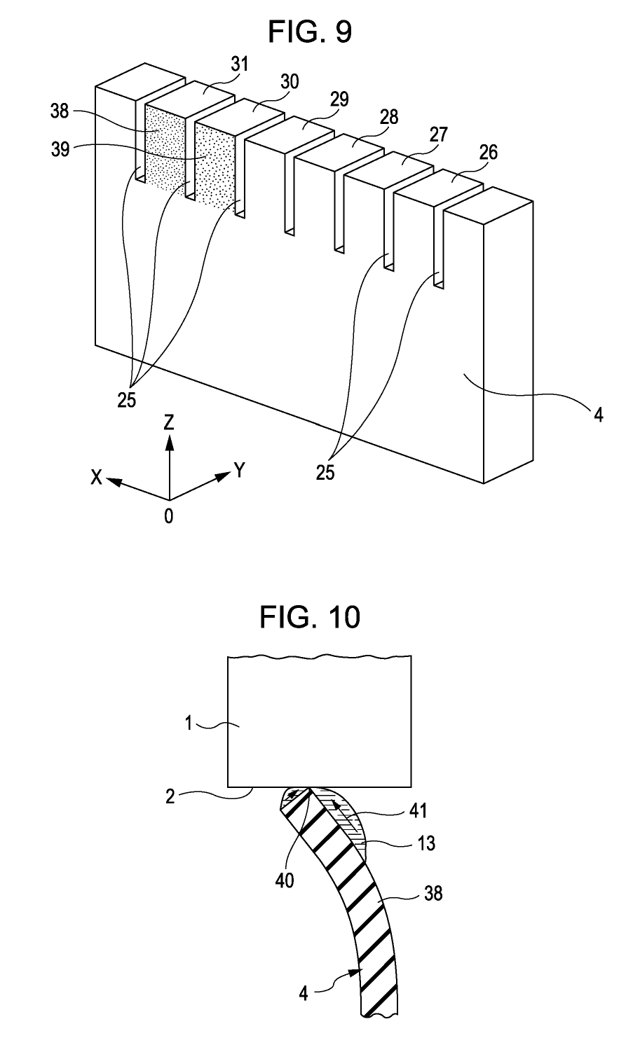

FIG. 9 is a perspective view of a wiper 4 according to the third embodiment. Referring to FIG. 9, similar to the second embodiment, the wiper 4 according to the present embodiment has slits 25 that divide a portion of the wiper 4 that comes into contact with the discharge-port surface 2 into six segments corresponding to the discharge-port rows 14 to 19. Thus, the slits 25 serve to define wiper segments 26 to 31 in the wiper 4. More specifically, a wiper segment D 26 corresponding to the discharge-port row D 14, a wiper segment E 27 corresponding to the discharge-port row E 15, a wiper segment F 28 corresponding to the discharge-port row F 16, a wiper segment G 29 corresponding to the discharge-port row G 17, a wiper segment H 30 corresponding to the discharge-port row H 18, and a wiper segment J 31 corresponding to the discharge-port row J 19 are provided. An inkjet recording apparatus according to the present embodiment is similar to the inkjet recording apparatus shown in FIG. 1 except the processing-liquid ejecting unit 9 is replaced by a processing-liquid transferring unit 22. A recording head 1 of the present embodiment is similar to the recording head according to the first embodiment shown in FIG. 3.

In the wiper 4 according to the present embodiment, the wiper segment J 31 and the wiper segment H 30 have a wiper-segment-J surface 38 and a wiper-segment-H surface 39, respectively, that face the discharge-port surface 2, and the wiper-segment-J surface 38 and the wiper-segment-H surface 39 have different roughness. Due to the difference in surface roughness, when the wiper 4 comes into contact with the processing-liquid transferring unit 22 as shown in FIGS. 4A to 4F, the wiper-segment-J surface 38, which has a high surface roughness and a large surface area, can hold a relatively large amount of processing liquid while an amount of processing liquid that can be held by the wiper-segment-H surface 39, which has a low surface roughness, is relatively small. In the present embodiment, wiper segment surfaces other than the wiper-segment-J surface 38 and the wiper-segment-H surface 39 have a relatively low surface roughness, similar to the wiper-segment-H surface 39.

FIG. 10 is a side view illustrating the movement of the processing liquid 13 in the process of wiping the discharge-port surface 2 with an end portion 40 of the wiper-segment-J surface 38. In FIG. 10, when a relatively large amount of processing liquid is applied, that is, when the wiper 4 has a high surface roughness, the processing liquid 13 moves in a direction shown by the arrow 41 as the wiper 4 moves. Thus, a large amount of processing liquid 13 is applied to the discharge-port surface 2.

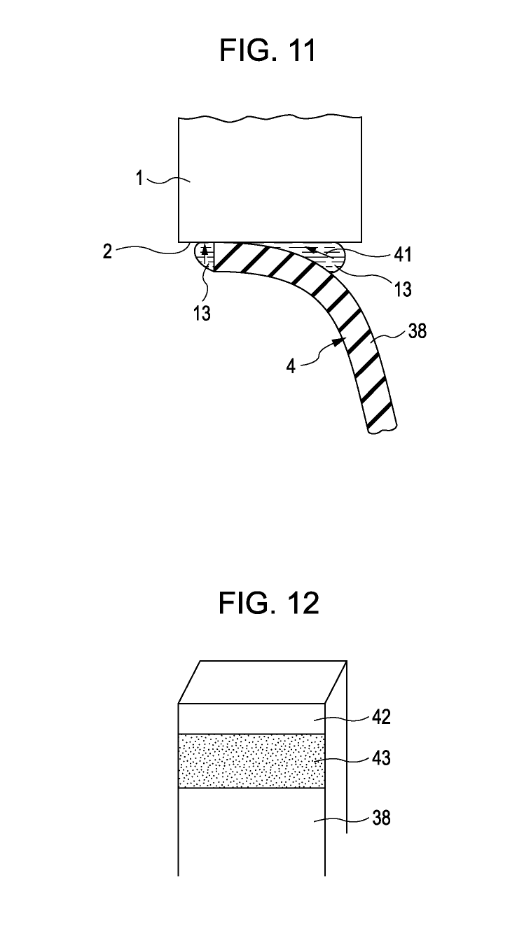

FIG. 11 is a side view illustrating the movement of the processing liquid 13 in the process of wiping the discharge-port surface 2 by bringing the wiper-segment-J surface 38 into contact with the discharge-port surface 2. Also in this case, a phenomenon similar to that in the case where the end portion 40 is brought into contact with the discharge-port surface 2 occurs. However, in this case, the discharge-port surface 2 will be damaged if the surface is excessively rough. In addition, if the surface roughness is extremely high, there is a possibility that sufficient wiping effect cannot be obtained. FIG. 12 is a perspective view illustrating an exemplary structure of the wiper-segment-J surface 38 that can avoid the above-described problem. Referring to FIG. 12, in the case where the surface 38 is rough, a portion 42 having a low surface roughness is provided at an end of the wiper 4 (wiper-segment-J surface 38) that comes into contact with the discharge-port surface 2. In addition, a portion 43 having a high surface roughness is provided in an area closer to the center than the portion 42 so that the portion 43 does not come into contact with the discharge-port surface 2. Thus, the wiper-segment-J surface 38 that corresponds to the discharge-port row J 19 to which a relatively large amount of processing liquid 13 is applied can have a two-section structure as shown in FIG. 12. Thus, in the present embodiment, the wiper-segment-J surface 38 includes the portion 42 having a low surface roughness that comes into contact with the discharge-port surface 2 and the processing-liquid transferring unit 22 and the portion 43 having a high surface roughness that comes into contact with the processing-liquid transferring unit 22 but does not come into contact with the discharge-port surface 2.

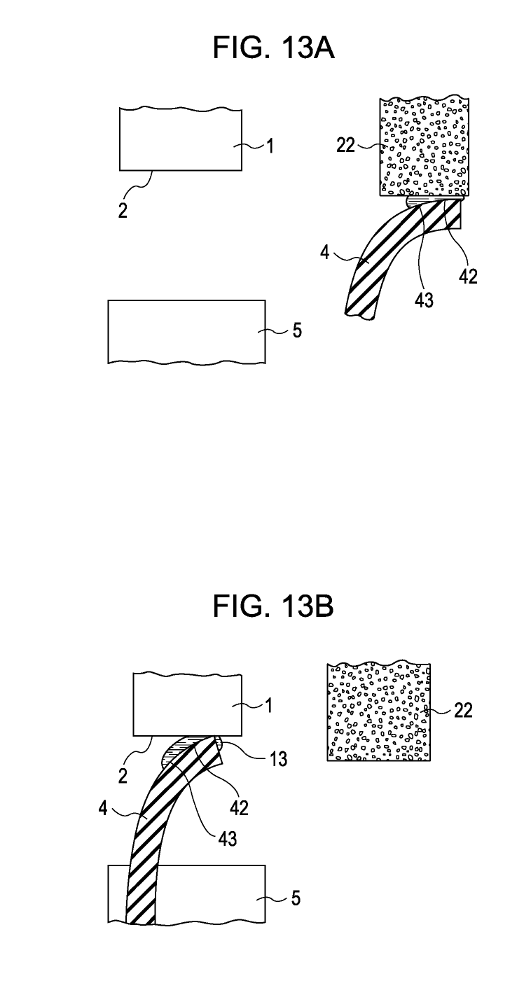

FIGS. 13A and 13B are side views illustrating the movement of the wiper-segment-J surface 38 of the wiper 4 shown in FIG. 12 and the movement of the processing liquid 13. FIG. 13A shows the state in which the wiper 4 is in contact with the processing-liquid transferring unit 22. FIG. 13B shows the state in which the wiper 4 is in contact with the discharge-port surface 2. As shown in FIG. 13A, when the wiper 4 comes into contact with the processing-liquid transferring unit 22, which functions as the processing-liquid applying unit, both the portion 42 (end portion) with a low surface roughness and the portion 43 with a high surface roughness are brought into contact with the processing-liquid transferring unit 22, and the portion 43 having a high surface roughness is caused to retain the processing liquid 13. When the wiper 4 wipes the discharge-port surface 2, as shown in FIG. 13B, only the end portion 42 with a low surface roughness is brought into contact with the discharge-port surface 2. In the process of wiping the discharge-port surface 2 with the portion 42 with a low surface roughness, the portion 43 with a high surface roughness serves to supply the processing liquid 13 to the wiped area. Thus, the portion 42 with a low surface roughness comes into contact with the discharge-port surface 2. Therefore, the amount of processing liquid applied to the discharge-port rows 14 to 19 can be adjusted for each of the discharge-port rows 14 to 19 by adjusting the surface roughness of the portion 43. Thus, sufficient wiping effect can be provided.

As an example, a wiper having the structure of the present embodiment was prepared in which the surface roughness (Ra) of the wiper-segment-J surface 38 was set to 25 μm by sandblasting. The surface roughness of the other wiper segment surfaces, such as the wiper-segment-H surface 39, was set to 6.3 μm. Then, as shown in FIG. 10, an end portion of the wiper 4 was brought into contact with the discharge-port surface 2 such that wiper-segment-J surface 38 faces the discharge-port row J 19 and the wiper-segment-H surface 39 faces the discharge-port row H 18. Red ink was supplied to the discharge-port row J 19 and green ink was supplied to the discharge-port row H 18. Inks similar to those used in the first embodiment shown in FIG. 3 were supplied to the other discharge-port rows. Then, the recording operation was performed at DUTY 25% for each ink by recording images on twenty A4-size sheets while performing the wiping process once every time a single A4-size sheet was recorded on. As a result, satisfactory recording results were obtained. The amount of processing liquid transferred to the wiper-segment-J surface 38 from the processing-liquid transferring unit 22 was 0.4 mg for each cycle of the wiping process. The amount of processing liquid transferred to each of the other segment surfaces was 0.1 mg for each cycle of the wiping process.

In the above-described example, sandblasting was performed to change (adjust) the surface roughness of each wiper segment surface of the wiper 4. However, the present embodiment is not limited to this. For example, the surface roughness of each wiper segment can also be changed by surface treatment using strong alkali or strong acid. Alternatively, the surface roughness can also be changed by subjecting a mold for forming the wiper 4 to a crimping process or the like so that an irregular surface can be formed on the mold.

### Fourth Embodiment

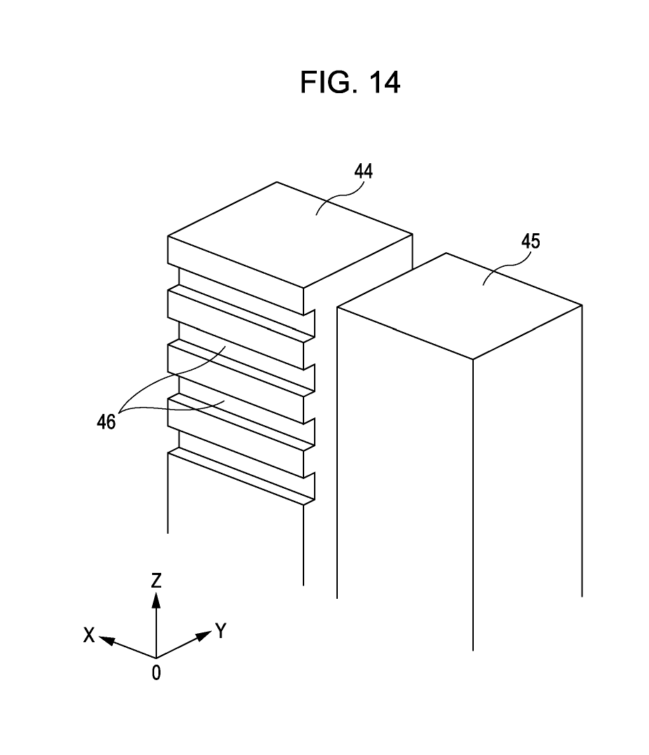

FIG. 14 is a perspective view of the main part of a wiper 4 according to a fourth embodiment. An inkjet recording apparatus according to the present embodiment is similar the inkjet recording apparatus shown in FIG. 1 except the processing-liquid ejecting unit 9 is replaced by the processing-liquid transferring unit 22. A recording head 1 of the present embodiment is similar to the recording head according to the first embodiment shown in FIG. 3. The structure and movement of the wiper 4 according to the present embodiment will now be described. Referring to FIG. 14, a wiper segment J 44 of the wiper 4 corresponds to the discharge-port row J 19 and a wiper segment H 45 of the wiper 4 corresponds to the discharge-port row H 18. A plurality of horizontal grooves 46 are formed in a surface of the wiper segment J 44 that comes into contact with the discharge-port surface 2. The shape of the grooves 46 changes when the wiper 4 comes into contact with the processing-liquid transferring unit 22.

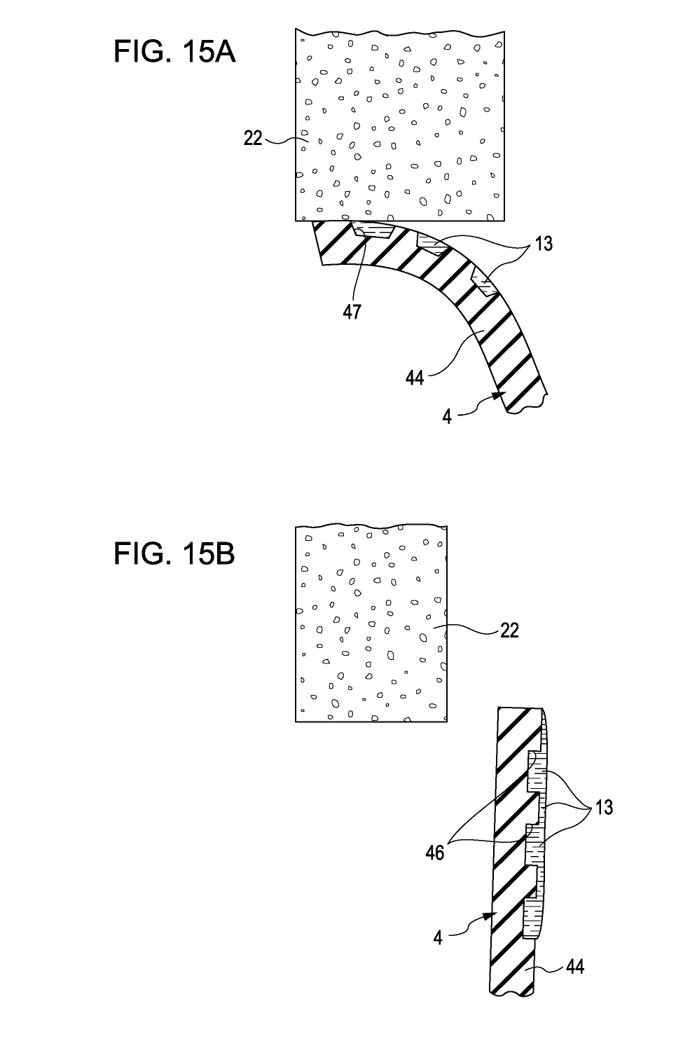

FIGS. 15A and 15B are side views illustrating the manner in which the processing liquid 13 is transferred from the processing-liquid transferring unit 22 onto the wiper 4 according to the present embodiment. FIG. 15A shows the state in which the wiper 4 is in contact with the processing-liquid transferring unit 22 and FIG. 15B shows the state after the processing liquid 13 is transferred onto the wiper 4. In FIGS. 15A and 15B, when the wiper 4 comes into contact with the processing-liquid transferring unit 22, which functions as the processing-liquid applying unit, the wiper segment J 44 warps due to the contact force applied thereto and accordingly the grooves 46 are widened. The processing liquid 13 transferred to the wiper 4 is retained in the widened grooves 47. Then, when the wiper 4 is separated from the processing-liquid transferring unit 22, the size of the grooves 47 returns to the original size. Due to the difference in capacity between the grooves 46 in the original size and the widened grooves 47, a large amount of processing liquid 13 is applied to the surface of the wiper segment J 44. Thus, the amount of processing liquid 13 applied to the wiper 4 can be changed by changing the depth and the size of the grooves 46.

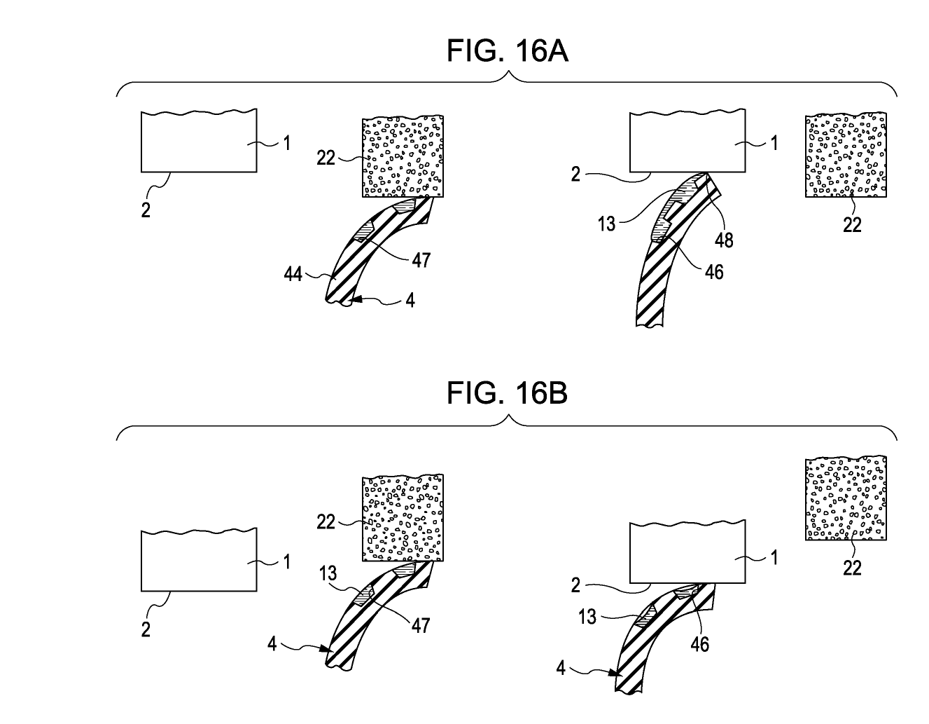

FIGS. 16A and 16B are side views illustrating the movement of the wiper segment J 44 when the wiper segment J 44 is brought into contact with the processing-liquid transferring unit 22 and the discharge-port surface 2. FIG. 16A shows the case in which the contact force applied between the wiper segment J 44 and the discharge-port surface 2 is weaker than that applied between the wiper segment J 44 and the processing-liquid transferring unit 22. FIG. 16B shows the case in which the contact force applied between the wiper segment J 44 and the discharge-port surface 2 is stronger than that applied between the wiper segment J 44 and the processing-liquid transferring unit 22. In the case of FIG. 16A, since the contact force applied when the wiper segment J 44 comes into contact with the discharge-port surface 2 is weaker than that applied when the wiper segment J 44 comes into contact with the processing-liquid transferring unit 22, an end portion 48 of the wiper segment J 44 can wipe the discharge-port surface 2 while the processing liquid 13 is supplied to the discharge-port surface 2 from the grooves 46. In the case of FIG. 16B, since the contact force applied when the wiper segment J 44 comes into contact with the discharge-port surface 2 is stronger than that applied when the wiper segment J 44 comes into contact with the processing-liquid transferring unit 22, the width of the grooves 46 in the process of wiping the discharge-port surface 2 is larger than in the state in which the wiper segment J 44 is in contact with the processing-liquid transferring unit 22. Therefore, the grooves 46 serve to retain the processing liquid 13 on the wiper 4 and it is difficult to wipe the discharge-port surface 2 with a desired amount of processing liquid 13 applied thereto.

As an example, a wiper having the structure of the present embodiment was prepared in which the size of each groove 46 in the wiper segment J 44 was set to 1 mm in the X direction, 0.1 mm in the Y direction, and 0.04 mm in the Z direction. The grooves 46 were not formed in the wiper segment H 45 (see FIG. 14) disposed next to the wiper segment J 44. The wiper segment J 44 corresponded to the discharge-port row J for the red ink, and the wiper segment H 45 corresponded to the discharge-port row H for the green ink. Inks similar to those used in the first embodiment shown in FIG. 3 were supplied to the other discharge-port rows. Then, the recording operation was performed at DUTY 25% for each ink by recording images on twenty A4-size sheets while performing the wiping process once every time a single A4-size sheet was recorded on. As a result, satisfactory recording results were obtained. In the wiping process, the positions of the processing-liquid transferring unit 22 and the discharge-port surface 2 in the vertical direction were adjusted such that the contact force between the wiper 4 and the processing-liquid transferring unit 22 was 300 g and the contact force between the wiper 4 and the discharge-port surface 2 was 150 g. The amount of processing liquid applied to the wiper segment J 44 was 0.4 mg for each cycle of the wiping process, and the amount of processing liquid applied to each of the other segments was 0.1 mg for each cycle of the wiping process.

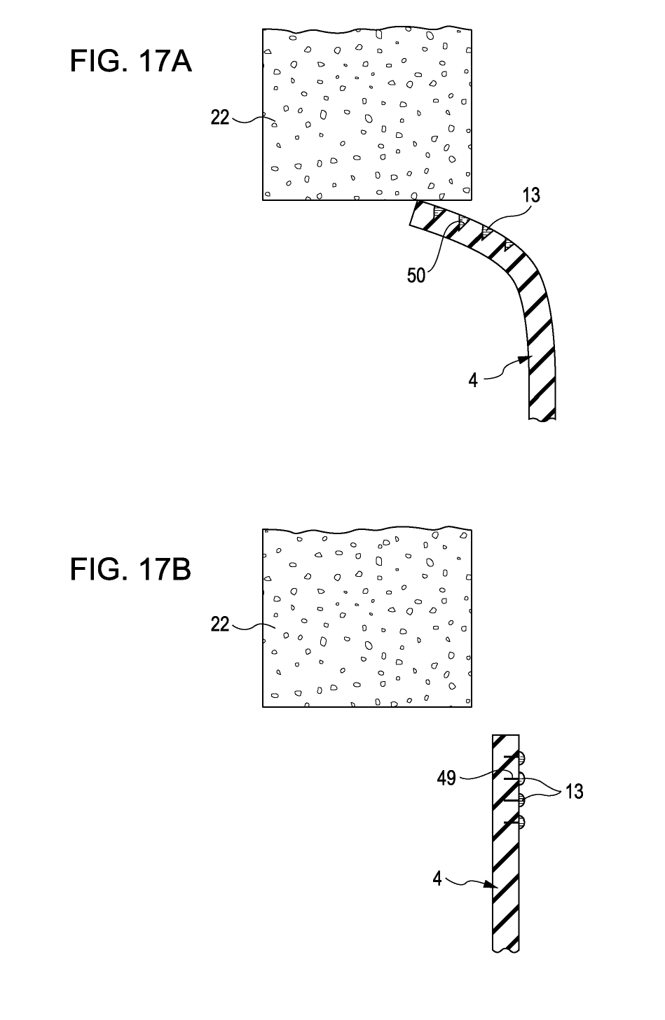

In the above-described example, the grooves 46 were formed by forming grooves in a mold for forming the wiper 4 in advance. In the case where the shape of the grooves 46 is complex, the grooves 46 can be formed by laser processing or the like. It is not always necessary that the grooves 46 have a certain width in the Z direction in FIG. 14. FIGS. 17A and 17B are sectional views of a wiper segment in which horizontal cut portions 49 are formed instead of the horizontal grooves 46. FIG. 17A shows the state in which the wiper segment is in contact with the processing-liquid transferring unit 22 and FIG. 17B shows the state after the processing liquid 13 is transferred onto the wiper segment. Similar to the above-described grooves 46, the amount of processing liquid 13 that can be transferred to the wiper segment can be adjusted simply by forming a certain number of cut portions 49 at certain positions of the wiper segment.

In FIG. 17, when the wiper 4 comes into contact with the processing-liquid transferring unit 22, the cut portions 49 are widened due to the contact load applied thereto and the processing liquid 13 is retained by the widened cut portions 50. When the wiper 4 is separated from the processing-liquid transferring unit 22, the widened cut portions 50 return to the cut portions 49 in the original state. Due to the difference in capacity between the cut portions 49 in the original state and the widened cut portions 50, a large amount of (or a predetermined amount of) processing liquid 13 can be applied to the surface of the wiper 4 (or wiper segment).

### Fifth Embodiment

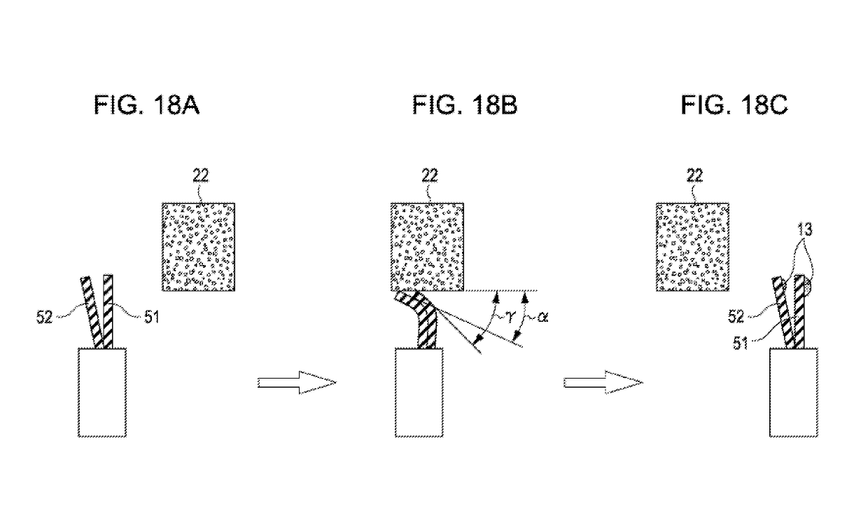

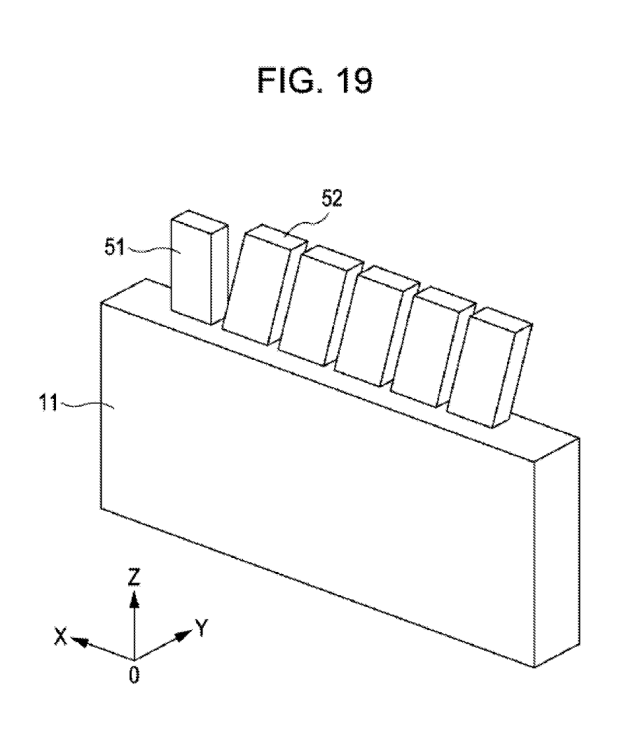

FIGS. 18A to 18C are side views illustrating an operation in which a wiper 4 according to a fifth embodiment is brought into contact with the processing-liquid transferring unit 22. FIG. 18A shows the state before the wiper 4 comes into contact with the processing-liquid transferring unit 22. FIG. 18B shows the state in which the wiper 4 is being in contact with the processing-liquid transferring unit 22. FIG. 18C shows the state after the wiper 4 is separated from the processing-liquid transferring unit 22. FIG. 19 is a perspective view illustrating the attachment angles of the wiper segments according to the present embodiment. Referring to FIG. 19, a wiper segment J 51 corresponds to the discharge-port row J 19, and a wiper segment H 52 corresponds to the discharge-port row H 18. The wiper segment J 51, to which a large amount of processing liquid is to be applied, is set to the wiper-holding unit 11 so as to form a relatively gentle slope so that the angle (contact angle) between the wiper segment J 51 and the processing-liquid transferring unit 22, which functions as the processing-liquid applying unit, is relatively small. The wiper segment H 52, which does not require a large amount of processing liquid to be applied thereto, is set to the wiper-holding unit 11 so as to form a relatively steep slope so that the angle (contact angle) between the wiper segment H 52 and the processing-liquid transferring unit 22 is relatively large. In the present embodiment, as shown in FIG. 19, the wiper segments corresponding to the discharge-port rows 14 to 19 are formed of individual blade-shaped members, and are attached to the wiper-holding unit 11 such that the wiper segments are disposed parallel to each other with gaps therebetween.

The wiper segment J 51 comes into contact with the processing-liquid transferring unit 22 at a small contact angle, and therefore receives a small contact force from the processing-liquid transferring unit 22. Thus, a force with which the processing liquid is removed from the processing-liquid transferring unit 22 is also small. In comparison, the wiper segment H 52 comes into contact with the processing-liquid transferring unit 22 at a large contact angle, and therefore receives a large contact force from the processing-liquid transferring unit 22. Thus, a force with which the processing liquid is removed from the processing-liquid transferring unit 22 is also large. Consequently, the amount of processing liquid transferred and applied to the wiper segment J 51 is smaller than the amount of processing liquid transferred and applied to the wiper segment H 52. As an example, a wiper having the structure of the present embodiment was prepared in which the contact of the wiper segment J 51 (angle α in FIG. 18B) was set to 45° and the contact angle of the wiper segment H 52 (angle γ in FIG. 18B) was set to 60°. The wiper segment J 51 corresponded to the discharge-port row J 19 for the red ink, and the wiper segment H 52 corresponded to the discharge-port row H 18 for the green ink. Inks similar to those used in the first embodiment were supplied to the other discharge-port rows.

It is obvious that the attachment angle of each wiper segment has a correlation with the contact angle between the wiper segment and the processing-liquid transferring unit 22. In the above-mentioned example, as shown in FIG. 19, all of the wiper segments corresponding to the discharge-port rows other than the discharge-port rows H 18 and J 19 were structured such that the contact angle thereof is equal to the contact angle α of the wiper segment J 51. The recording operation was performed at DUTY 25% for each ink by recording images on twenty A4-size sheets while performing the wiping process once every time a single A4-size sheet was recorded on. As a result, satisfactory recording results were obtained. The amount of processing liquid transferred to the wiper segment H 52 was 0.4 mg for each cycle of the wiping process, and the amount of processing liquid transferred to each of the other wiper segments was 0.1 mg for each cycle of the wiping process.

### Sixth Embodiment

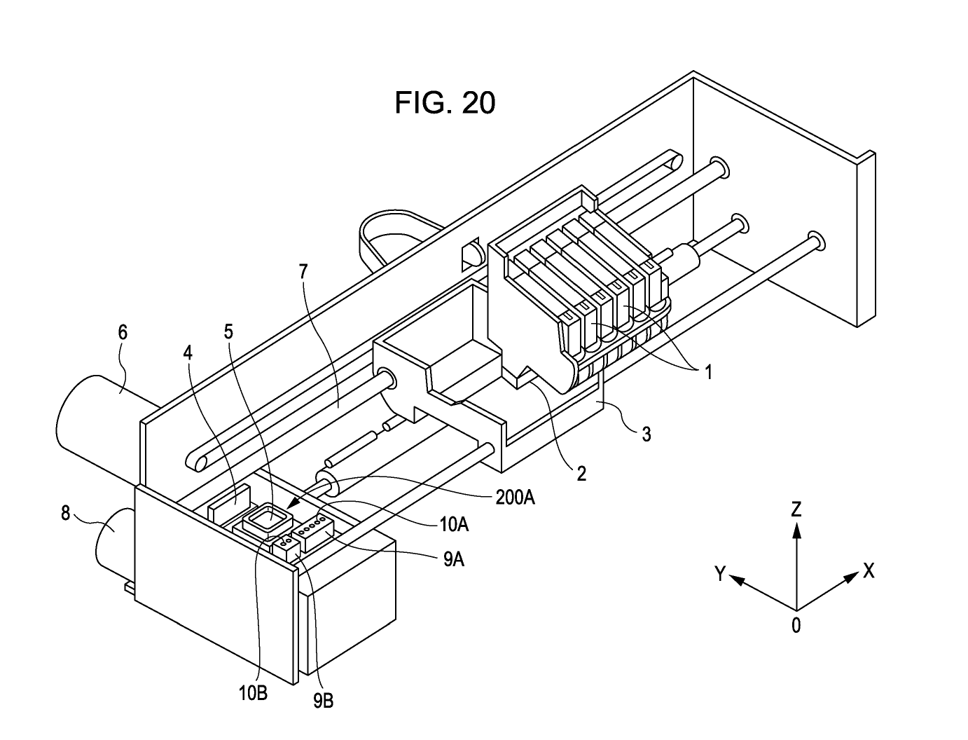

FIG. 20 is a perspective view of an inkjet recording apparatus according to a sixth embodiment. Referring to FIG. 20, an inkjet recording head 1 has a discharge-port surface 2 in which a plurality of discharge-port rows are formed in a predetermined pattern. The inkjet recording head 1 is mounted on a carriage 3. The carriage 3, on which the inkjet recording head 1 is mounted, is reciprocated in the X direction by a carriage motor 6 (main scanning). The carriage 3 that reciprocates is supported and guided by a guide shaft 7. A recovery unit 200A for maintaining and recovering the ink discharge performance of the inkjet recording head 1 is disposed within a movable range of the carriage 3 at a position outside a recording area. The recording head 1 has a structure similar to that of the recording head 1 according to the first embodiment shown in FIG. 3.

The recovery unit 200A includes a wiper 4 for wiping the discharge-port surface 2 of the inkjet recording head 1, a cap 5 that can be tightly attached to the discharge-port surface 2 so as to cover the discharge-port rows, and a recovery-unit motor 8 for moving the wiper 4 in a wiping direction (Y direction). The recovery unit 200A also includes two processing-liquid ejecting units 9A and 9B. Each of the processing-liquid ejecting units 9A and 9B functions as a processing-liquid applying unit for applying the processing liquid to the discharge-port surface 2. The first processing-liquid ejecting unit 9A has first ejection ports 10A whose orientations are adjusted such that the processing liquid ejected from the first ejection ports 10A adheres to the discharge-port rows on the discharge-port surface 2. The second processing-liquid ejecting unit 9B has second ejection ports 10B whose orientations are adjusted such that the processing liquid ejected from the second ejection ports 10B adheres to the discharge-port rows on the discharge-port surface 2. The processing liquid is supplied from a processing-liquid container (processing liquid tank) to each of the processing-liquid ejecting units 9A and 9B by the operation of the recovery-unit motor 8, and is ejected from the ejection ports 10A and 10B.

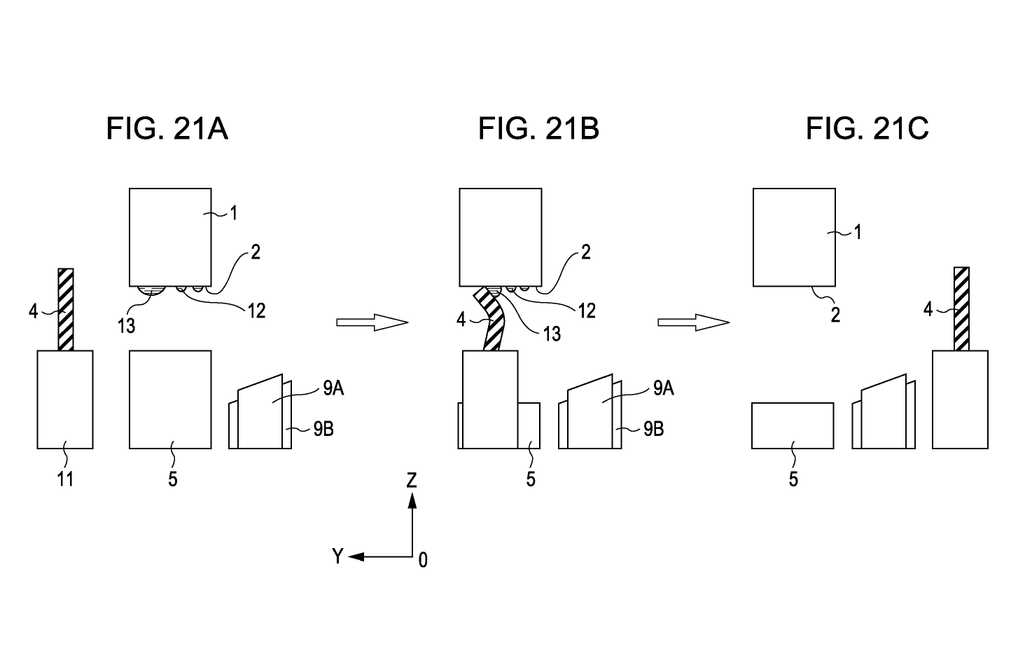

FIGS. 21A to 21C illustrate the operation of the wiper 4 according to the present embodiment. FIG. 21A shows the standby state, FIG. 21B shows the state in which the discharge-port surface 2 is being wiped, and FIG. 21C shows the state after the discharge-port surface 2 is wiped. FIGS. 21A to 21C are sectional views of FIG. 20 along the YZ plane. In FIGS. 21A to 21C, the wiper 4 is held by a wiper-holding unit 11. The wiper-holding unit 11 is gate-shaped so that the cap 5 and the first and second processing-liquid ejecting units 9A and 9B can pass through the wiper-holding unit 11 when the wiper-holding unit 11 is moved as shown in FIGS. 2B and 2C. Reference numeral 12 denotes ink droplets on the discharge-port surface 2, and reference numeral 13 denotes the processing liquid ejected from the processing-liquid ejecting units 9A and 9B, each of which functions the processing-liquid applying unit, and applied to the discharge-port surface 2. The height of the wiper 4 is adjusted such that the wiper 4 comes into contact with the discharge-port surface 2 in a predetermined manner. A process of wiping the discharge-port surface 2 (wiping process) is performed by moving the wiper 4 in the wiping direction while the processing liquid is applied to the discharge-port surface 2. In this process, if the ink droplets 12 are present on the discharge-port surface 2, the ink and the processing liquid are mixed with each other on the discharge-port surface 2.

As shown in FIG. 3, processing liquid K 20 adheres to the discharge-port surface 2 in a region surrounding the discharge-port row J 19 for the red ink and processing liquid L 21 adheres to the discharge-port surface 2 in regions surrounding the other discharge-port rows (from the discharge-port row D 14 for the cyan ink to the discharge-port row H 18 for the green ink). The processing liquid K 20 and the processing liquid L 21 are ejected from the ejection ports 10A and 10B in the processing-liquid ejecting units 9A and 9B, respectively, so as to adhere to the discharge-port surface 2.

The carriage 3 on which the recording head 1 is mounted is moved by the carriage motor 6 to a position where the inkjet recording head 1 faces the cap 5 in the recovery unit 200A. At this position, the processing liquid K 20 is ejected from the first processing-liquid ejecting unit 9A toward the discharge-port row J 19 on the discharge-port surface 2 and the processing liquid L 21 is ejected from the second processing-liquid ejecting unit 9B toward the discharge-port row D 14, the discharge-port row E 15, the discharge-port row F 16, the discharge-port row G 17, and the discharge-port row H 18. In the process of wiping the discharge-port surface 2, as shown in FIGS. 21A and 21B, the wiper 4 is moved in the Y direction and brought into contact with the discharge-port surface 2 after the processing liquid 13 (the processing liquid K 20 and the processing liquid L 21) is applied to the discharge-port surface 2. At this time, as shown in FIG. 3, the kind of the processing liquid applied to the discharge-port rows 14 to 19 is adjusted for each of the discharge-port rows 14 to 19, so that the discharge-port surface 2 can be wiped using the optimum kind of processing liquid.

Also in the present embodiment, the discharge-port surface 2 has six discharge-port rows from which different kinds of ink are discharged. The discharge-port rows include a discharge-port row D 14 having a plurality of discharge ports from which cyan ink is discharged. Similarly, the discharge-port rows include a discharge-port row E 15 for discharging magenta ink, a discharge-port row F 16 for discharging yellow ink, a discharge-port row G 17 for discharging black ink, a discharge-port row H 18 for discharging green ink, and a discharge-port row J 19 for discharging red ink. Each of the discharge-port rows has a plurality of discharge ports from which the corresponding ink is discharged.

As an example, a mixture of liquid glycerin and Acetylenol (50% aqueous solution of Acetylenol:glycerin 100%=2:100 by weight) was ejected from the ejection ports 10A of the first processing-liquid ejecting unit 9A. The thus-ejected processing liquid adhered to the discharge-port surface 2 and served as the processing liquid K 20. In addition, liquid glycerin 100% was ejected from the ejection ports 10B of the second processing-liquid ejecting unit 9B. The thus-ejected processing liquid adhered to the discharge-port surface 2 and served as the processing liquid L 21. The wiping process was performed while 0.1 mg of processing liquid was applied to each of the discharge-port rows. The recording operation was performed at DUTY 25% for each ink by recording images on twenty A4-size sheets while performing the wiping process once every time a single A4-size sheet was recorded on. As a result, satisfactory recording results were obtained. For comparison, liquid glycerin 100% was ejected from the first processing-liquid ejecting unit 9A and the wiping process was performed while 0.1 mg of processing liquid was applied to each of the discharge-port rows. As a result, recording defects, such as uneven density distribution, occurred in only the region recorded by red ink discharged from the discharge-port row J.

As for a method for ejecting the processing liquid, a pressurizing motor included in the recording apparatus was operated to apply pressure to the first and second processing-liquid ejecting units 9A and 9B, so that the processing liquid K 20 and the processing liquid L 21 were ejected toward the discharge-port surface 2 for a predetermined time interval. However, the present embodiment is not limited to the method of ejecting the processing liquid by applying pressure. For example, the processing liquid can also be transferred onto the discharge-port surface 2. In addition, the number of kinds of processing liquid to be used is not limited to two, and three or more kinds of processing liquid can also be used in accordance with the kinds of ink. In addition, the processing liquid is not limited to glycerin and a mixture of glycerin. For example, materials such as ethylene glycol, a mixture of ethylene glycol and glycerin, etc. which are adequate in view of the characteristics of the ink can be used as necessary. The cleaning effect obtained by the processing liquid is generally proportional to the dielectric constant of the processing liquid. Therefore, the dielectric constant of the processing liquid can be adjusted in accordance with the adhesion force of the ink, so that the wiping process can be performed using the optimum kind of processing liquid for each of the discharge-port rows.

### Seventh Embodiment

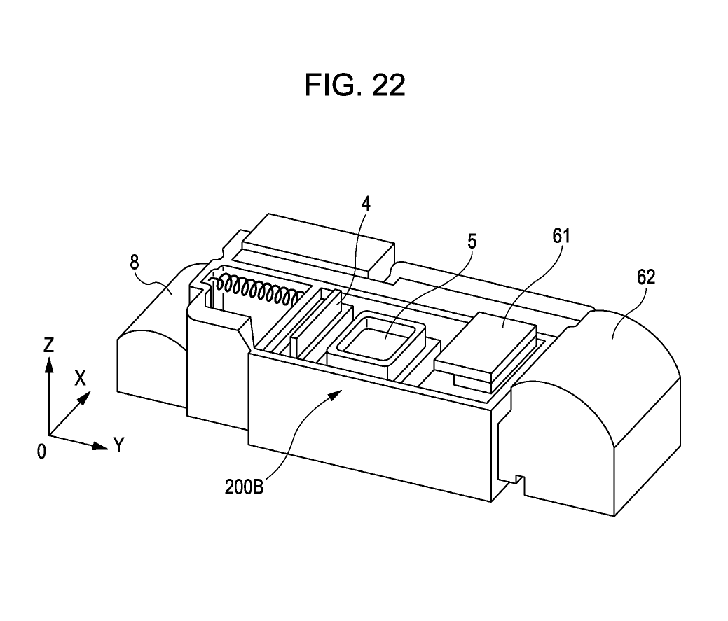

According to a seventh embodiment, instead of directly applying the processing liquid to the discharge-port surface 2, first, the processing liquid is transferred onto the wiper 4. Then, the wiping process is performed by bringing the wiper 4 into contact with a discharge-port surface. FIG. 22 is a perspective view of a recovery unit 200B according to the seventh embodiment. Referring to FIG. 22, a processing-liquid transferring unit 61 that functions as a processing-liquid applying unit is attached to the recovery unit 200B. The processing-liquid transferring unit 61 includes, for example, a porous body capable of retaining the processing liquid. When the wiper 4 comes into contact with the processing-liquid transferring unit 61, the processing liquid retained by the processing-liquid transferring unit 61 is transferred to the wiper 4. The recovery unit 200B also includes a processing-liquid tank 62 that functions as a processing-liquid supplying unit from which the processing liquid is supplied to the processing-liquid transferring unit 61.

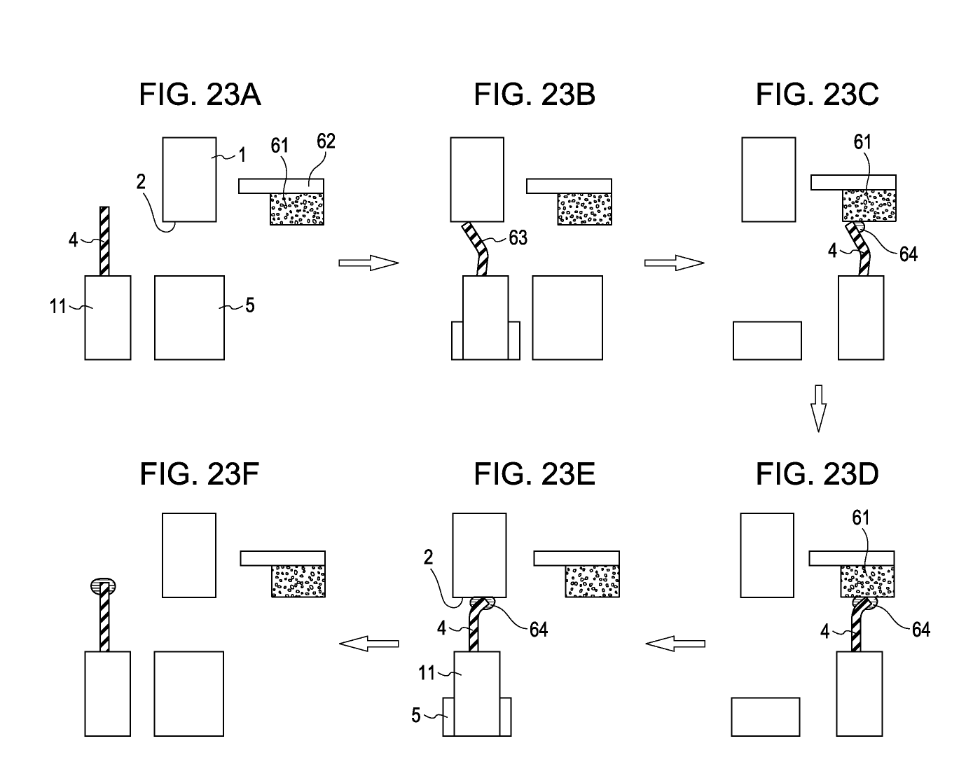

FIGS. 23A to 23F are diagrams illustrating the movement of the wiper 4 according to the present embodiment. FIGS. 23A to 23F are sectional views of FIG. 20 taken along the YZ plane. An inkjet recording apparatus according to the present embodiment is similar to the inkjet recording apparatus shown in FIG. 20 except the first and second processing-liquid ejecting units 9A and 9B are replaced by the processing-liquid transferring unit 61. The processing-liquid tank 62 that functions as the processing-liquid supplying unit is shown in FIG. 22. An inkjet recording head having the structure shown in FIG. 3 is used in the present embodiment. FIG. 23A shows the state in which the wiper 4 is in the stand-by state. FIG. 23B shows the state in which the wiper 4 passes by the discharge-port surface 2. FIG. 23C shows the state in which the wiper 4 comes into contact with the processing-liquid transferring unit 61 and the processing liquid is transferred to the wiper 4. FIG. 23D shows the state in which the wiper 4 starts moving in the opposite direction while the wiper 4 is in contact with the processing-liquid transferring unit 61. FIG. 23E shows the state in which the discharge-port surface 2 is wiped by the wiper 4 which is being moved in the opposite direction and on which the processing liquid is transferred. FIG. 23F shows the state in which the wiper 4 is returned to the standby position after the discharge-port surface 2 is wiped by the wiper 4 using the processing liquid. Although the wiper 4 is in contact with the discharge-port surface 2 in FIG. 23B, this is not always necessary. The inkjet recording head 1 can be moved to a position where the wiper 4 does not come into contact with the discharge-port surface 2.

Referring to FIG. 23C, the processing liquid is transferred from the processing-liquid transferring unit 61 to the wiper 4 while the wiper 4 is bent (curved) due to the contact load applied thereto. The processing liquid transferred to the wiper 4 is denoted by reference numeral 64. In FIG. 23D, the wiper 4 is bent in a direction opposite to that in FIG. 23C. Therefore, the processing liquid can be transferred to both surfaces of the wiper 4. After the wiper 4 is separated from the processing-liquid transferring unit 61, the wiper 4 comes into contact with the discharge-port surface 2 while the processing liquid 64 is retained thereon, as shown in FIG. 23E. Thus, the discharge-port surface 2 is wiped by the wiper 4 while the processing liquid is interposed between the discharge-port surface 2 and the wiper 4. After the wiper 4 wipes the discharge-port surface 2, the wiper 4 returns to the initial position shown in FIG. 23F. Thus, a standby state for the wiping process is reestablished.

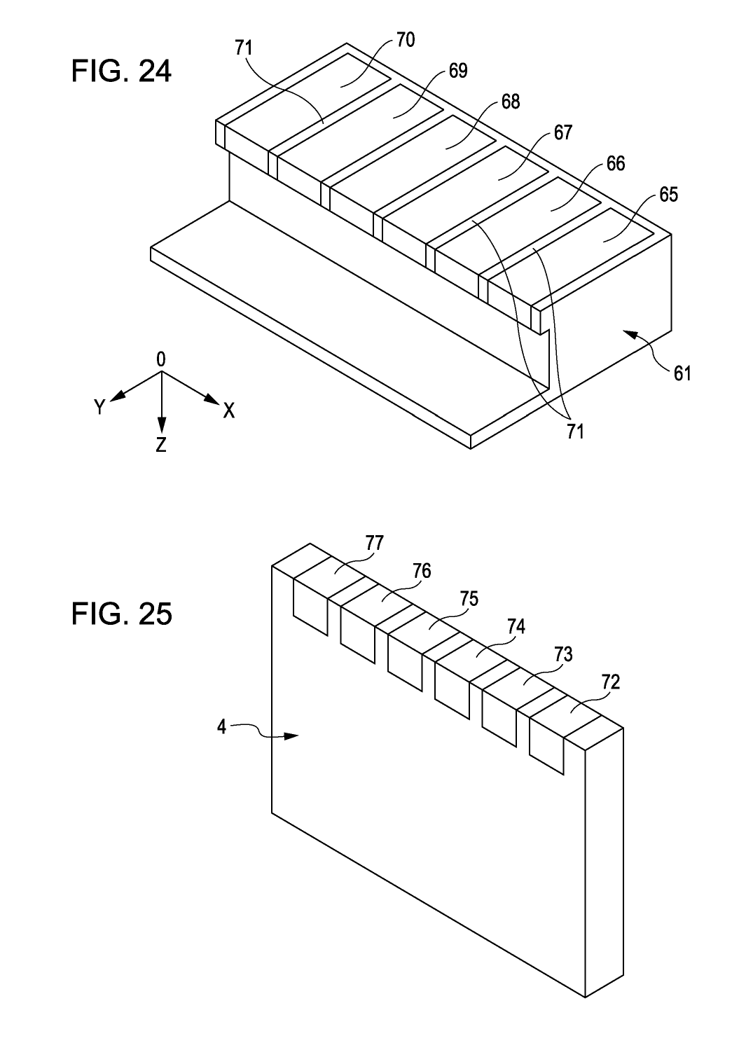

FIG. 24 is a perspective view of the processing-liquid transferring unit 61 according to the present embodiment viewed in the Z direction from the side at which the wiper 4 comes into contact with the processing-liquid transferring unit 61. Referring to FIGS. 24 and 3, a processing-liquid transferring segment D 65 corresponds to the discharge-port row D 14, a processing-liquid transferring segment E 66 corresponds to the discharge-port row E 15, a processing-liquid transferring segment F 67 corresponds to the discharge-port row F 16, a processing-liquid transferring segment G 68 corresponds to the discharge-port row G 17, a processing-liquid transferring segment H 69 corresponds to the discharge-port row H 18, and a processing-liquid transferring segment J 70 corresponds to the discharge-port row J 19. The processing-liquid transferring segments are sectioned from each other by partitions 71. Each of the processing-liquid transferring segments serves to transfer the processing liquid to the wiper 4 that comes into contact therewith. The partitions 71 extend to the interior of the processing-liquid transferring unit 61, and the processing-liquid transferring segments are connected to respective processing-liquid supplying segments of a processing-liquid supplying unit (processing-liquid container) 62.

FIG. 25 is a perspective view illustrating the state in which the processing liquid is transferred to the wiper 4 according to the present embodiment. In the wiping process illustrated in FIGS. 23A to 23F, when the wiper 4 comes into contact with the processing-liquid transferring unit 61 shown in FIG. 24 which functions as the processing-liquid applying unit, the processing liquid is transferred to segments of the wiper 4 that correspond to the discharge-port rows, as shown in FIG. 25. In FIG. 25, processing liquid D 72 corresponds to the discharge-port row D 14, processing liquid E 73 corresponds to the discharge-port row E 15, processing liquid F 74 corresponds to the discharge-port row F 16, processing liquid G 75 corresponds to the discharge-port row G 17, processing liquid H 76 corresponds to the discharge-port row G 18, and processing liquid J 77 corresponds to the discharge-port row J 19. The wiper that retains the processing liquid shown in FIG. 25 comes into contact with the discharge-port surface 2, as shown in FIG. 23E. Thus, the discharge-port rows can be wiped using suitable kinds of processing liquid applied thereto.

As an example, a mixture of glycerin and Acetylenol (50% aqueous solution of Acetylenol:glycerin 100%=2:100 by weight) was applied to the processing-liquid transferring segment J 70, and liquid glycerin 100% was applied to the other processing-liquid transferring segments. The discharge-port row J 19 was wiped with the processing liquid J 77 (mixture of glycerin and Acetylenol) applied thereto and the other discharge-port rows were wiped using glycerin 100% applied thereto. An amount of processing liquid applied (transferred) by each of the processing-liquid transferring segments was 0.1 mg for each cycle of the wiping process. The recording operation was performed at DUTY 25% for each ink by recording images on twenty A4-size sheets while performing the wiping process once every time a single A4-size sheet was recorded on.

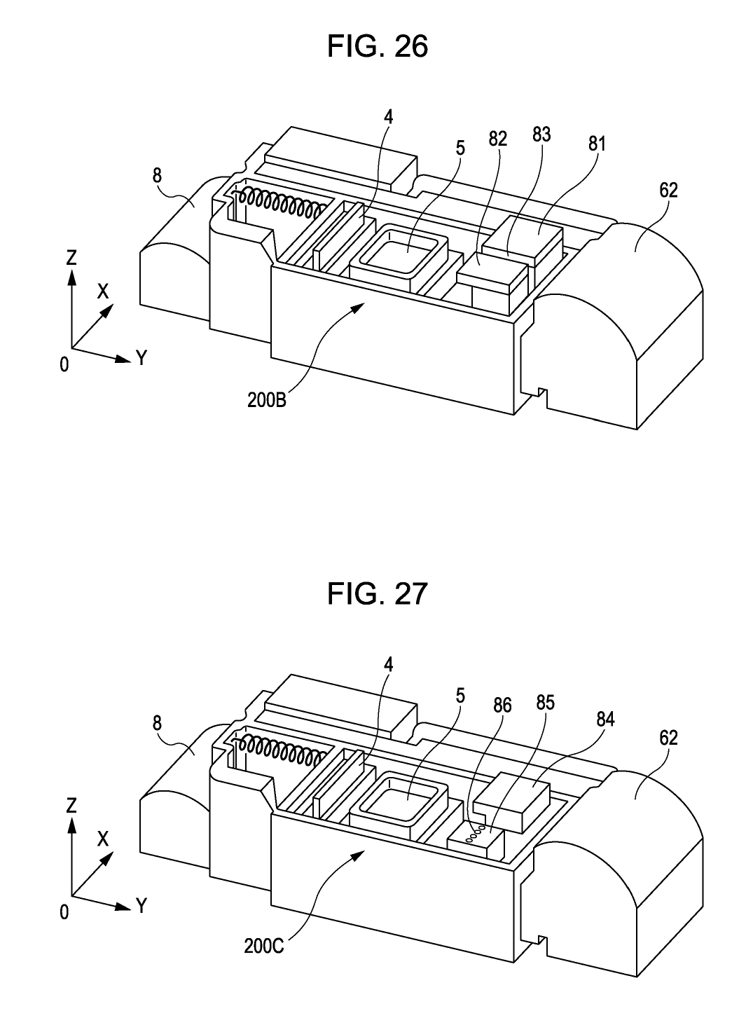

FIG. 26 is a perspective view illustrating a modification of the recovery unit 200B according to the present embodiment. In the present embodiment, the processing-liquid transferring unit 61 includes the processing-liquid transferring segments 65 to 70 which are sectioned from each other so that different kinds of processing liquid can be applied to the discharge-port rows. However, the present embodiment is not limited to this. For example, as shown in FIG. 26, the processing-liquid transferring unit, which functions as the processing-liquid applying unit, can include a first processing-liquid transferring unit 81 and a second processing-liquid transferring unit 82 which are arranged parallel with each other in a direction that crosses the wiping direction of the wiper, that is, in the X direction along which the discharge-port rows are arranged. In the example shown in FIG. 26, a gap 83 is formed between the two processing-liquid transferring units 81 and 82. The size of the gap 83 can be set as small as possible.

### Eighth Embodiment

FIG. 27 is a perspective view of a recovery unit 200C according to an eighth embodiment. An inkjet recording apparatus according to the present embodiment is similar to the inkjet recording apparatus shown in FIG. 20 except the first and second processing-liquid ejecting units 9A and 9B are replaced by a processing-liquid transferring unit 84 and a processing-liquid ejecting unit 85. A recording head 1 of the present embodiment is similar to the recording head according to the first embodiment shown in FIG. 3. In the sixth embodiment, the two processing-liquid ejecting unit 9A and 9B are used to apply the processing liquid to the discharge-port surface 2. In the seventh embodiment, the processing-liquid transferring unit 61 (or the processing-liquid transferring units 81 and 82) is used to apply the processing liquid to the wiper, and the kind of the processing liquid is set for each of the discharge-port rows. In comparison, the recovery unit 200C according to the present embodiment includes the processing-liquid transferring unit 84 and the processing-liquid ejecting unit 85, as shown in FIG. 27. The processing liquid ejected from ejection ports 86 of the processing-liquid ejecting unit 85 is different from the processing liquid transferred by the processing-liquid transferring unit 84. Thus, different kinds of processing liquid can be applied to the discharge-port rows.

### Ninth Embodiment

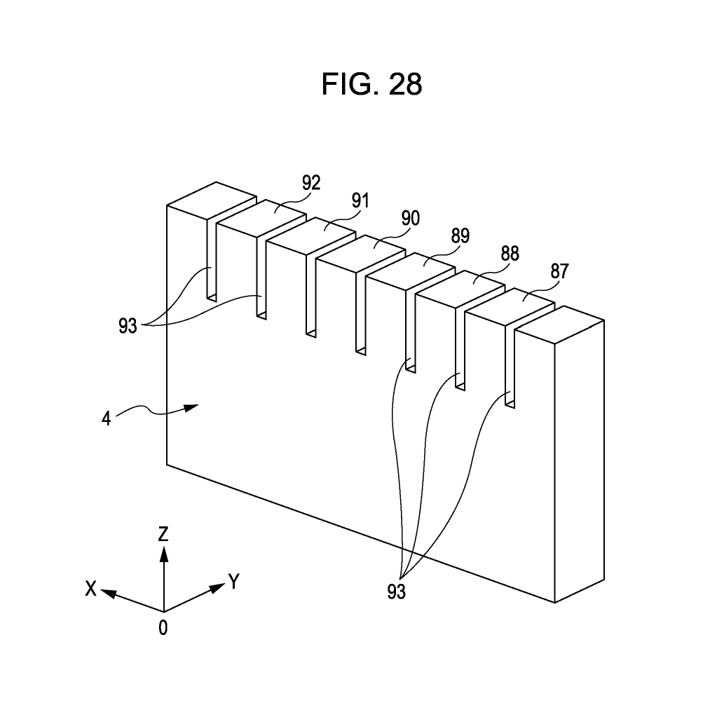

FIG. 28 is a perspective view of a wiper 4 according to a ninth embodiment. FIG. 29 is a perspective view of a processing-liquid transferring unit according to the ninth embodiment. An inkjet recording apparatus according to the present embodiment is similar to the inkjet recording apparatus shown in FIG. 20 except the first and second processing-liquid ejecting units 9A and 9B are replaced by the processing-liquid transferring unit 61. A recording head 1 of the present embodiment is similar to the recording head according to the first embodiment shown in FIG. 3.

Referring to FIGS. 28 and 3, a wiper segment D 87 corresponds to the discharge-port row D 14, a wiper segment E 88 corresponds to the discharge-port row E 15, a wiper segment F 89 corresponds to the discharge-port row F 16, a wiper segment G 90 corresponds to the discharge-port row G 17, a wiper segment H 91 corresponds to the discharge-port row H 18, and a wiper segment J 92 corresponds to the discharge-port row J 19. These wiper segments are sectioned from each other by slits 93 such that the wiper segments correspond to the respective discharge-port rows. The slits 93 serve to prevent different kinds of processing liquid from being mixed with each other in the process of transferring the processing liquid or in the process of wiping the discharge-port surface.

The wiper 4 shown in FIG. 28 can also be used in the structures of the sixth to eighth embodiments. Assume that the wiper 4 according to the present embodiment is used together with the processing-liquid transferring unit 61 according to the seventh embodiment shown in FIG. 24. In such a case, if even a small amount of processing liquid enters the slits 93, the processing liquid moves away from the end of the wiper 4 (in the -Z direction in FIG. 28) due to gravity. Therefore, the wiping process is not affected. A member for removing the processing liquid from the slits 93 can also be additionally used.

FIG. 29 is a perspective view illustrating a modification of the processing-liquid transferring unit according to the present embodiment. Referring to FIG. 29, a processing-liquid transferring unit 94 according to the modification is structured such that a plurality of slit cleaners 95 is added to the processing-liquid transferring unit 61 shown in FIG. 22. Similar to the processing-liquid transferring unit 61, the processing-liquid transferring unit 94 also functions as the processing-liquid applying unit. The slit cleaners 95 are disposed at positions corresponding to the slits 93 in the wiper 4. The width of the slit cleaners 95 in the X direction is smaller than that of the slits 93. When the wiper 4 is moved toward the processing-liquid transferring segments, the slits 93 are moved such that the slit cleaners 95 pass through the respective slits 93. Accordingly, the processing liquid in the slits 93 of the wiper 4 is removed by the slit cleaners 95, and thus the slits 93 are cleaned. When the amount of processing liquid that adheres to the slit cleaners 95 reaches a certain level, the processing liquid falls in the −Z direction in FIG. 29 due to gravity. If the processing liquid is not heavy enough to fall, the processing liquid collects at the end of each slit cleaner 95. End portions of the slit cleaners 95 are positioned such that the end portions do not come into contact with the discharge-port surface 2. Therefore, different kinds of processing liquid can be prevented from being mixed with each other.

In the structure shown in FIG. 29, steps 96 are provided between the partitions 71 and the processing-liquid transferring segments 65 to 70 in the vertical direction. The steps 96 also serve to prevent the different kinds of processing liquid from being mixed with each other when the different kinds of processing liquid are transferred to the wiper segments. If the wiper 4 shown in FIG. 28 is used, the different kinds of processing liquid that are applied to the wiper segments 87 to 92 are prevented from being mixed with each other when the different kinds of processing liquid are transferred to the wiper 4 from the processing-liquid transferring unit 94. The different kinds of processing liquid are also prevented from being mixed with each other in the process of wiping the discharge-port surface 2. Therefore, the discharge-port rows can be reliably wiped with the corresponding kinds of processing liquid applied thereto.

### Tenth Embodiment

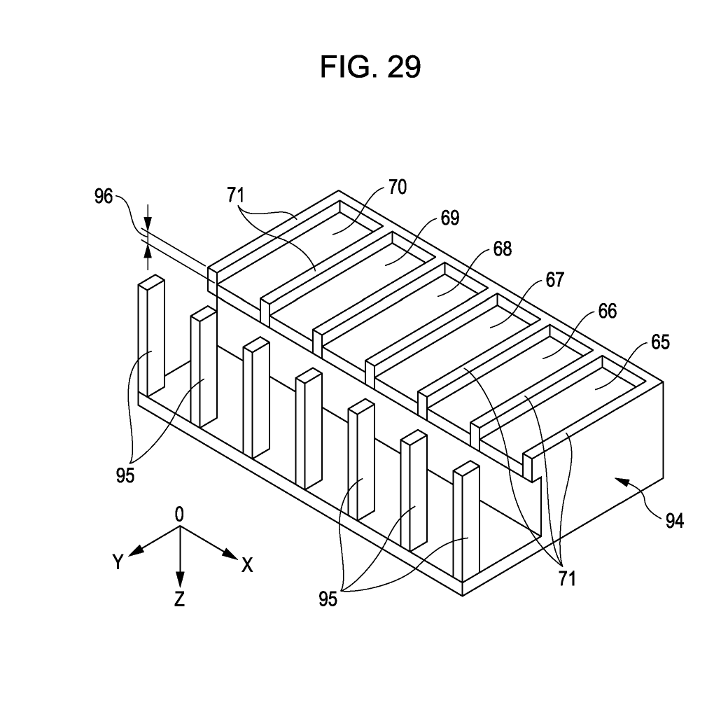

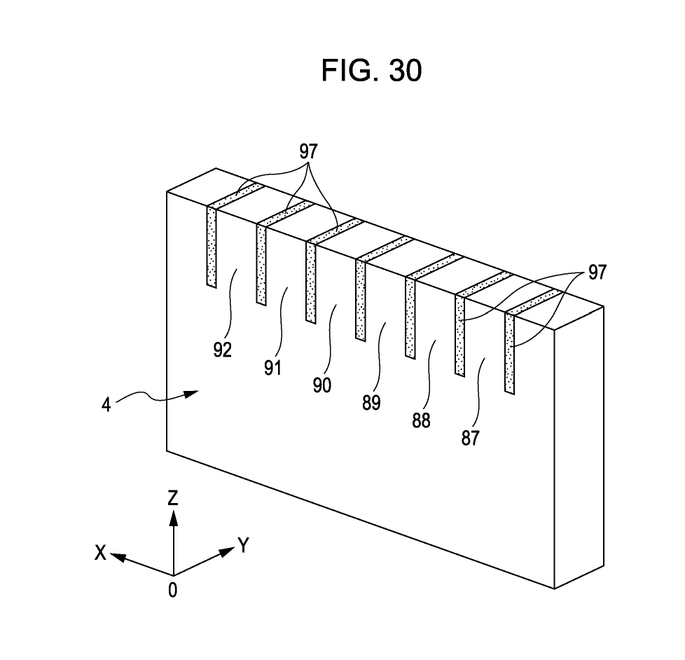

FIG. 30 is a perspective view of a wiper 4 according to a tenth embodiment. In the ninth embodiment, the wiper segments corresponding to the respective discharge-port rows are sectioned from each other by the slits 93 formed in the wiper 4. However, the wiper segments can also be sectioned from each other by changing the chemical characteristics of the surface of the wiper 4. An inkjet recording apparatus according to the present embodiment is similar to the inkjet recording apparatus shown in FIG. 20 except the first and second processing-liquid ejecting units 9A and 9B are replaced by the processing-liquid transferring unit 61. A recording head 1 of the present embodiment is similar to the recording head according to the first embodiment shown in FIG. 3.

Referring to FIG. 30, the wiper 4 includes wiper segments 87 to 92 which correspond to the discharge-port rows 14 to 19, respectively, and which are sectioned from each other by water-repellent portions 97. If the processing liquid applied to the wiper 4 tries to spread in the X direction in FIG. 30, the water-repellent portions 97 prevent the processing liquid from spreading. Therefore, when different kinds of processing liquid are applied to the wiper segments 87 to 92, the processing liquid on each wiper segment is prevented from being mixed with the processing liquid on other wiper segments. Thus, the different kinds of processing liquid applied to the respective wiper segments are prevented from being mixed with each other when they are transferred from the processing-liquid transferring unit 61, which functions as the processing-liquid applying unit, or when the discharge-port surface 2 is wiped. As a result, the discharge-port rows can be more reliably wiped with the corresponding kinds of processing liquid applied thereto.

### Eleventh Embodiment

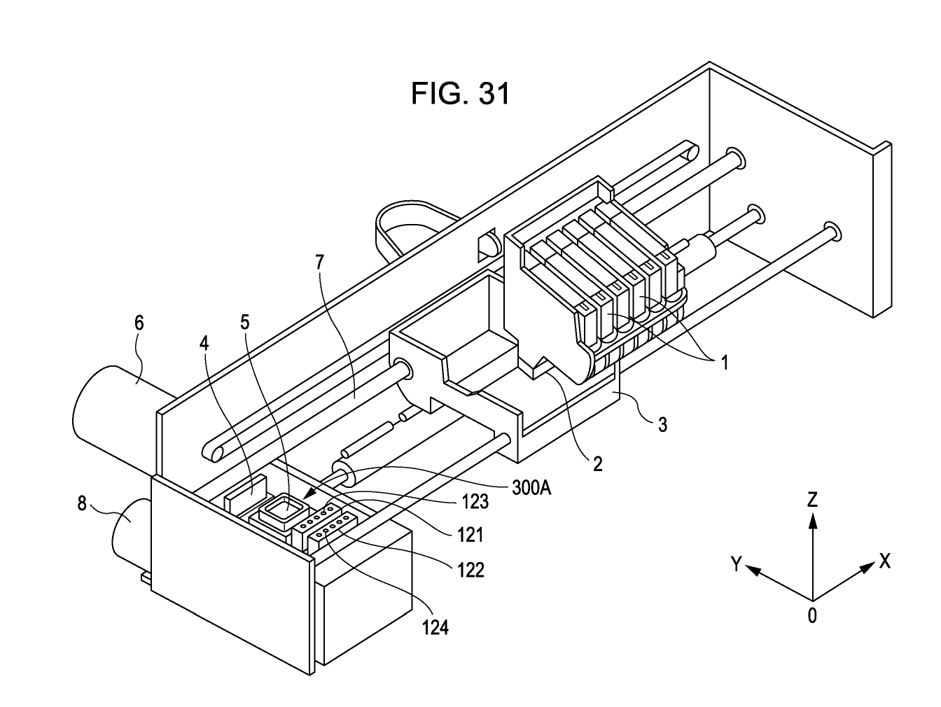

FIG. 31 is a perspective view of an inkjet recording apparatus according to an eleventh embodiment. Referring to FIG. 31, an inkjet recording head 1 has a discharge-port surface 2 in which a plurality of discharge-port rows are formed in a predetermined pattern. The inkjet recording head 1 is mounted on a carriage 3. The carriage 3, on which the inkjet recording head 1 is mounted, is reciprocated in the X direction by a carriage motor 6 (main scanning). The carriage 3 that reciprocates is supported and guided by a guide shaft 7. A recovery unit 200A for maintaining and recovering the ink discharge performance of the inkjet recording head 1 is disposed within a movable range of the carriage 3 at a position outside a recording area. The recording head 1 has a structure similar to that of the recording head 1 according to the first embodiment shown in FIG. 3.

The recovery unit 300A includes a wiper 4 for wiping the discharge-port surface 2 of the inkjet recording head 1, a cap 5 that can be tightly attached to the discharge-port surface 2 so as to cover the discharge-port rows, and a recovery-unit motor 8 for moving the wiper 4 in a wiping direction (Y direction). The recovery unit 300A also includes two processing-liquid ejecting units 121 and 122. Each of the processing-liquid ejecting units 121 and 122 functions as a processing-liquid applying unit for applying the processing liquid to the discharge-port surface 2. The first processing-liquid ejecting unit 121 has first ejection ports 123 whose orientations are adjusted such that the processing liquid ejected from the first ejection ports 123 adheres to the discharge-port rows on the discharge-port surface 2. The first processing-liquid ejecting unit 121 and the second processing-liquid ejecting unit 122 are arranged in the Y direction, that is, the direction in which the wiper 4 is moved (direction in which the ejection ports are arranged in each discharge-port row). The second processing-liquid ejecting unit 122 has second ejection ports 124 whose orientations are adjusted such that the processing liquid ejected from the second ejection ports 124 adheres to the discharge-port rows on the discharge-port surface 2. The processing liquid is supplied from a processing-liquid container (processing liquid tank) to each of the processing-liquid ejecting units 121 and 122 by the operation of the recovery-unit motor 8, and is ejected from the ejection ports 123 and 124.

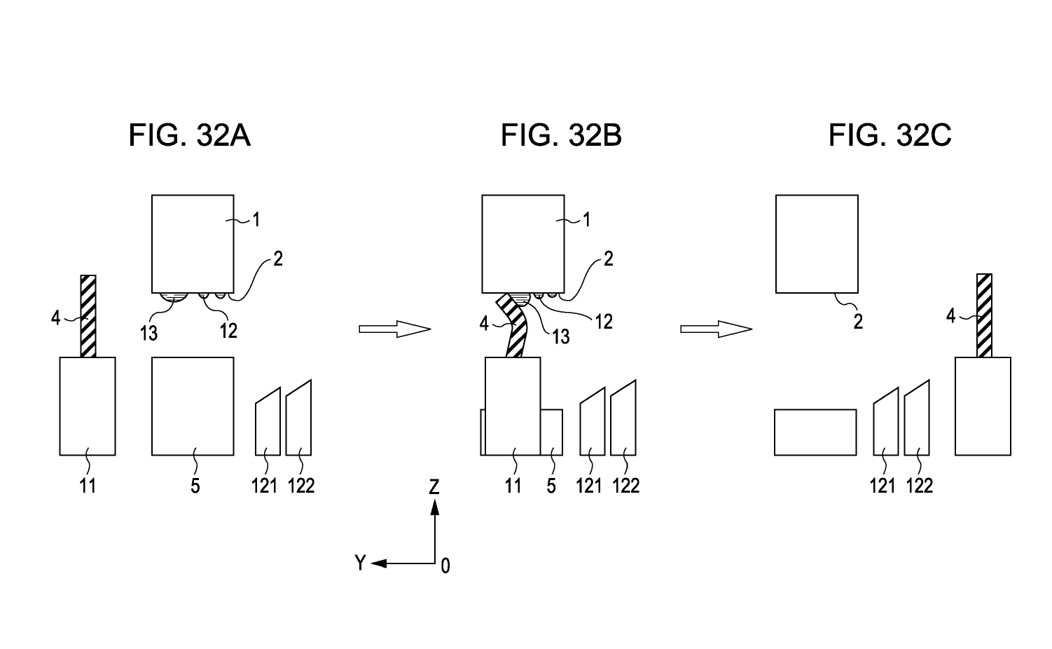

FIGS. 32A to 32C illustrate the operation of the wiper 4 according to the present embodiment. FIG. 32A shows the standby state, FIG. 32B shows the state in which the discharge-port surface 2 is being wiped, and FIG. 32C shows the state after the discharge-port surface 2 is wiped. FIGS. 32A to 32C are sectional views of FIG. 20 along the YZ plane. In FIGS. 32A to 32C, the wiper 4 is held by a wiper-holding unit 11. The wiper-holding unit 11 is gate-shaped so that the cap 5 and the first and second processing-liquid ejecting units 121 and 122 can pass through the wiper-holding unit 11 when the wiper-holding unit 11 is moved as shown in FIGS. 2B and 2C. Reference numeral 12 denotes ink droplets on the discharge-port surface 2, and reference numeral 13 denotes the processing liquid ejected from the processing-liquid ejecting units 121 and 122 and applied to the discharge-port surface 2. The height of the wiper 4 is adjusted such that the wiper 4 comes into contact with the discharge-port surface 2 in a predetermined manner. A process of wiping the discharge-port surface 2 (wiping process) is performed by moving the wiper 4 while the processing liquid is applied to the discharge-port surface 2. In this process, if the ink droplets 12 are present on the discharge-port surface 2, the ink and the processing liquid are mixed with each other on the discharge-port surface 2.

The carriage 3 on which the recording head 1 is mounted is moved by the carriage motor 6 to a position where the inkjet recording head 1 faces the cap 5 in the recovery unit 300A. At this position, the processing liquid is ejected from the first processing-liquid ejecting unit 121 toward the discharge-port surface 2. In addition, the processing liquid is also ejected from the second processing-liquid ejecting unit 122 toward the discharge-port surface 2. In the process of wiping the discharge-port surface 2, as shown in FIGS. 32A and 32B, the wiper 4 is moved in the −Y direction and brought into contact with the discharge-port surface 2 after the processing liquid 13 is applied to the discharge-port surface 2. A plurality of discharge-port rows 14 to 19 are formed on the discharge-port surface 2, and cyan ink, magenta ink, yellow ink, black ink, green ink, and red ink are discharged from the discharge-port rows 14 to 19, respectively.

In the present embodiment, the processing liquid to be used is selected from a plurality of kinds of processing liquid in accordance with the ambient temperature. An example will be described. When the ambient temperature was 15 degrees Celsius or more in the recording operation, the wiping process was performed after glycerin (100%) was applied to the discharge-port surface 2 by the first processing-liquid ejecting unit 121. When the ambient temperature was less than 15 degrees Celsius in the recording operation, the wiping process was performed after 40% aqueous solution of glycerin was applied to the discharge-port surface 2 by the second processing-liquid ejecting unit 122. The processing-liquid ejecting units 121 and 122 received the different kinds of processing liquid from a plurality of processing liquid containers (not shown) or a plurality of supplying sections of a processing liquid container. The amount of consumption of the processing liquid in each cycle of the wiping process was 0.5 mg for each kind of the processing liquid.

The recording operation was performed at DUTY 25% by recording images on twenty A4-size sheets using four colors of ink, that is, cyan, magenta, yellow, and black ink while performing the wiping process once every time a single A4-size sheet was recorded on. The process was performed at the ambient temperature of 10 degrees Celsius and at the ambient temperature of 30 degrees Celsius. As a result, satisfactory recording results were obtained. For comparison, glycerin (100%) was supplied to the second processing-liquid ejecting unit 122 and the wiping process was performed after glycerin (100%) was applied to the discharge-port surface 2 even when the ambient temperature was less than 15 degrees Celsius. As a result, recording defects, such as uneven density distribution, occurred when the ambient temperature was 10 degrees Celsius. This is because the amount of ejection of liquid glycerin (100%) was reduced due to the reduction in the ambient temperature.

As for a method for ejecting the processing liquid, a pressurizing motor included in the recording apparatus was operated to apply pressure to the first and second processing-liquid ejecting units 121 and 122, so that different kinds of processing liquid were ejected toward the discharge-port surface 2 in accordance with the ambient temperature. However, the present embodiment is not limited to the method of ejecting the processing liquid by applying pressure. For example, the processing liquid can also be transferred onto the discharge-port surface 2. In addition, the number of kinds of processing liquid to be used is not limited to two, and three or more kinds of processing liquid can also be used in accordance with the kinds of ink. In addition, the processing liquid is not limited to glycerin and aqueous solution of glycerin. For example, materials such as ethylene glycol, a mixture of ethylene glycol and glycerin, etc. which are adequate in view of the characteristics of the ink can be used as necessary. The cleaning effect obtained by the processing liquid is generally proportional to the dielectric constant of the processing liquid. Therefore, the dielectric constant of the processing liquid can be adjusted in accordance with the adhesion force of the ink, so that the wiping process can be performed using the optimum kind of processing liquid in accordance with the ambient temperature.

### Twelfth Embodiment

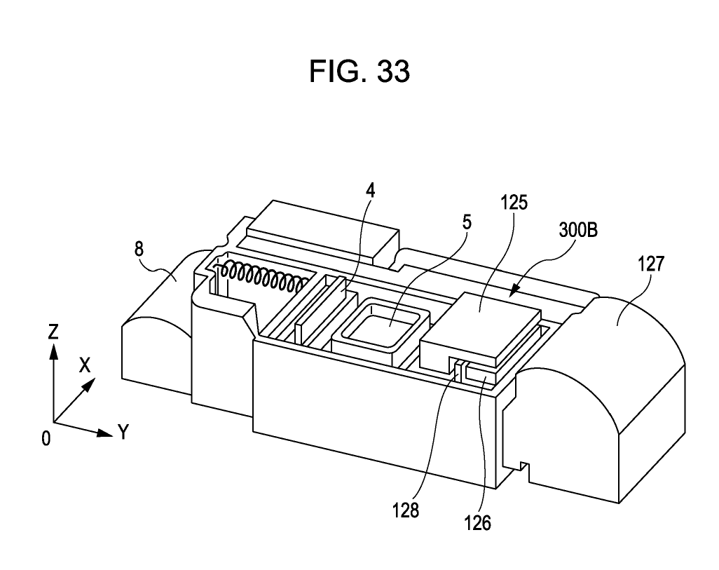

According to a twelfth embodiment, instead of directly applying the processing liquid to the discharge-port surface 2, first, the processing liquid selected in accordance with the ambient temperature is applied to the wiper 4. Then, the wiping process is performed by bringing the wiper 4 into contact with a discharge-port surface. A recording head 1 of the present embodiment is similar to the recording head according to the first embodiment shown in FIG. 3. FIG. 33 is a perspective view of a recovery unit 300B according to the present embodiment. Referring to FIG. 33, the recovery unit 300B includes a first processing-liquid transferring unit 125 and a second processing-liquid transferring unit 126. The processing-liquid transferring units 125 and 126 are arranged in the moving direction of the wiper 4, that is, in the Y direction. Each of the processing-liquid transferring units 125 and 126 functions as a processing-liquid applying unit which retains the processing liquid and transfers the processing liquid to the wiper 4 when the wiper 4 comes into contact therewith. Each of the processing-liquid transferring units 125 and 126 includes, for example, a porous body capable of retaining the processing liquid.

The recovery unit 300B includes a processing-liquid container 127 that functions as a processing-liquid supplying unit that supplies the processing liquid to the processing-liquid transferring units 125 and 126. The recovery unit 300B has a stopper 128 for limiting the moving range of the wiper 4. An inkjet recording apparatus according to the present embodiment is similar to the inkjet recording apparatus shown in FIG. 31 except the recovery unit 300A is replaced by the recovery unit 300B.

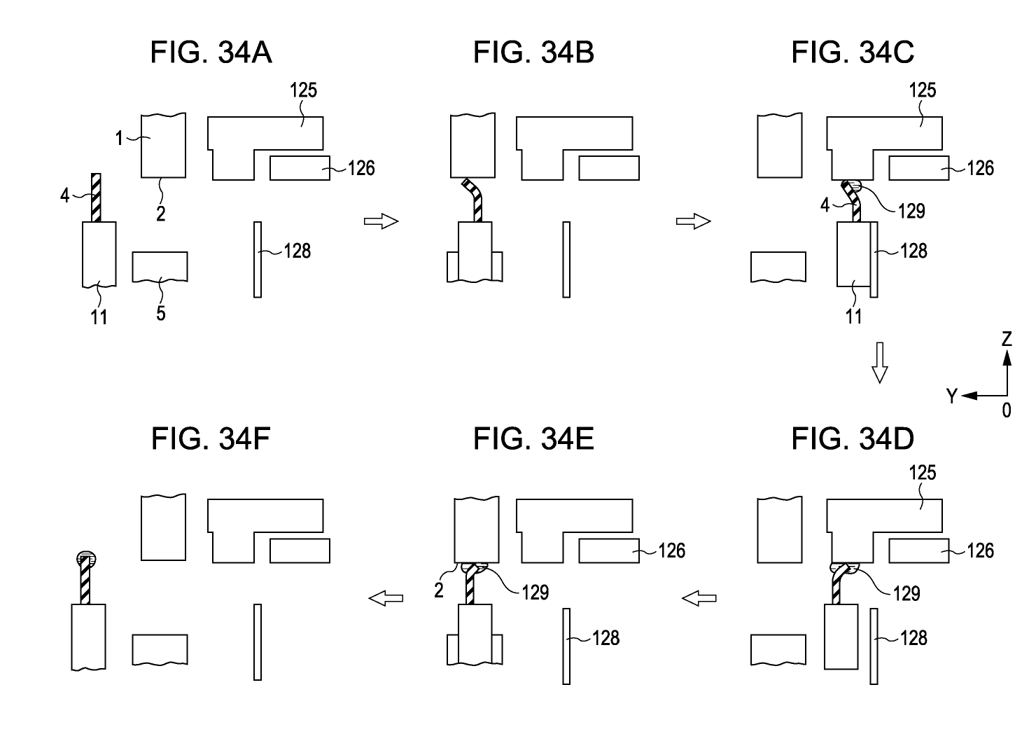

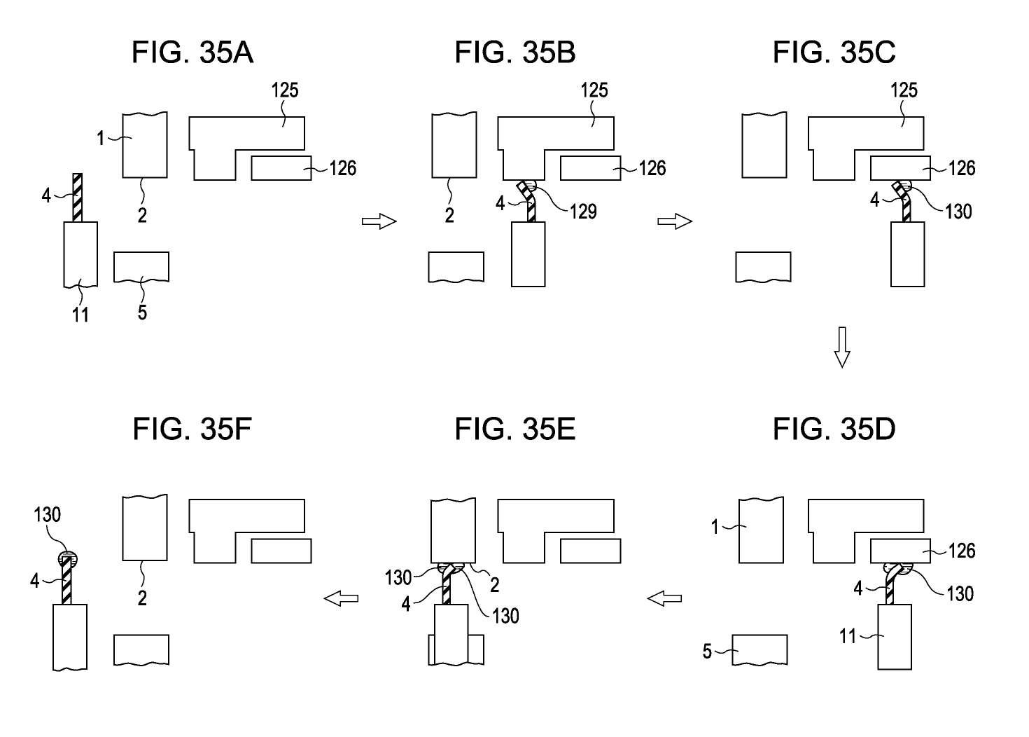

FIGS. 34A to 34F are diagrams illustrating the operation in which the moving range of the wiper 4 according to the present embodiment is limited. FIGS. 35A to 35F are diagrams illustrating the operation in which the moving range of the wiper 4 according to the present embodiment is not limited. FIGS. 34A to 34F and 35A to 35F are sectional views of FIG. 31 taken along the YZ plane. In the state shown in FIG. 34A, the recording head 1 mounted on the carriage 3 is moved to the position where the recording head 1 faces a cap 5 of the recovery unit 300B. When the wiping process is started, as shown in FIG. 34B, the wiper 4 passes by the discharge-port surface 2 and moves toward the first and second processing-liquid transferring units 125 and 126. Although the wiper 4 is in contact with the discharge-port surface 2 in FIG. 34B, this is not always necessary. The recording head 1 can be moved to a position where the wiper 4 does not come into contact with the discharge-port surface 2.

As shown in FIG. 34C, when the wiper 4 comes into contact with the first processing-liquid transferring unit 125, the wiper 4 is bent due to the contact load and the processing liquid adheres to the wiper 4. The processing liquid applied to the wiper 4 is denoted by reference numeral 129. The wiper-holding unit 11 comes into contact with the stopper 128 while the wiper 4 is in contact with the first processing-liquid transferring unit 125. Then, the wiper 4 reverses the moving direction thereof, as shown in FIG. 34D, without moving further toward the second processing-liquid transferring unit 126 and starts moving in the opposite direction. Thus, the wiper 4 is deformed in a direction opposite to that in FIG. 34C, and the processing liquid 129 is applied to both surfaces of the wiper 4. The wiper 4 is separated from the first processing-liquid transferring unit 125 while the processing liquid 129 is applied thereto. Then, as shown in FIG. 34E, the wiper 4 comes into contact with the discharge-port surface 2 and wipes the discharge-port surface 2 while the processing liquid is interposed between the wiper 4 and the discharge-port surface 2. Then, as shown in FIG. 34F, the wiper 4 returns to the initial position shown in FIG. 34A. Thus, a standby state for the wiping process is reestablished.

Next, the wiping process in which the stopper 128 is removed and not used will be described. In the state shown in FIG. 35A, the recording head 1 is moved in the X direction to the position where the recording head 1 faces the cap 5. When the wiping process is started, as shown in FIG. 35B, the wiper 4 passes by the discharge-port surface 2 and moves toward the first and second processing-liquid transferring units 125 and 126. Also in this case, it is not always necessary that the wiper 4 come into contact with the discharge-port surface 2, and the recording head 1 can be moved to a position where the wiper 4 does not come into contact with the discharge-port surface 2. As shown in FIG. 35B, when the wiper 4 comes into contact with the first processing-liquid transferring unit 125, the wiper 4 is bent due to the contact load and the processing liquid is transferred to the wiper 4. The processing liquid applied to the surface of the wiper 4 is denoted by reference numeral 129. After the wiper 4 comes into contact with the first processing-liquid transferring unit 125, the wiper 4 moves still further and comes into contact with the second processing-liquid transferring unit 126, as shown in FIG. 35C. The wiper 4 is bent due to the contact load and the processing liquid is transferred to the wiper 4 from the second processing-liquid transferring unit 126. The processing liquid transferred to the wiper 4 from the second processing-liquid transferring unit 126 is denoted by reference numeral 130.

Then, the wiper 4 reverses the moving direction thereof, as shown in FIG. 34D, while the wiper 4 is in contact with the second processing-liquid transferring unit 126. Thus, the wiper 4 is deformed in a direction opposite to that in FIG. 35C, and therefore the processing liquid 130 adheres to both surfaces of the wiper 4. The wiper 4 is separated from the second processing-liquid transferring unit 126 while the processing liquid 130 is applied thereto. Then, as shown in FIG. 35E, the wiper 4 comes into contact with the discharge-port surface 2 and wipes the discharge-port surface 2 while the processing liquid 130 is interposed between the wiper 4 and the discharge-port surface 2. Then, as shown in FIG. 35F, the wiper 4 returns to the initial position shown in FIG. 35A. Thus, a standby state for the wiping process is reestablished.

In the operation illustrated in FIGS. 35A to 35F, two kinds of processing liquid 129 and 130 are transferred to the wiper 4 from the processing-liquid transferring units 125 and 126, respectively, which each function as a processing-liquid applying unit. When only one of the two kinds of processing liquid is used, the other kind of processing liquid can be stopped from being supplied to the corresponding processing-liquid transferring unit. More specifically, the processing liquid that is not used can be stopped from being supplied from the processing-liquid container 127 to the corresponding processing-liquid transferring unit. Thus, the two kinds of processing liquid 129 and 130 can be prevented from being mixed with each other. In the case where glycerin or the like is used as the processing liquid and velocity of the processing liquid is increased when the temperature is low, only a small amount of processing liquid adheres to the wiper that comes into contact with the processing-liquid transferring unit if the temperature is low. Therefore, the other kind of processing liquid is not affected even if two kinds of processing liquid are applied to the wiper.

In the operations of the wiper illustrated in FIGS. 34A to 34F and 35A to 35F, a plurality of processing-liquid transferring units, each of which functions as a processing-liquid applying unit, are provided and the stopper 128 is used in accordance with the ambient temperature. Thus, desired processing liquid can be selectively applied to the wiper 4. As a result, the wiping process can be performed using the optimum kind of processing liquid in accordance with the ambient temperature and the ink that adheres to the discharge-port surface can be effectively and efficiently removed.

Next, an example will be described. Glycerin 100% was contained in the first processing-liquid transferring unit 125, and 40% aqueous solution of glycerin was contained in the second processing-liquid transferring unit 126. When the ambient temperature was 15 degrees Celsius or more in the recording operation, the stopper 128 was disposed at a projecting position so that the stopper 128 can be used. When the ambient temperature was less than 15 degrees Celsius in the recording operation, the stopper 128 was moved to a standby position and was not used. Thus, the discharge-port surface was wiped using glycerin 100% as the processing liquid when the ambient temperature was 15 degrees Celsius or more, and was wiped using 40% aqueous solution of glycerin as the processing liquid when the ambient temperature was less than 15 degrees Celsius or more. The amount of consumption of the processing liquid in each cycle of the wiping process was 0.8 mg. When the ambient temperature was less than 15 degrees Celsius, the wiper 4 came into contact not only with the second processing-liquid transferring unit 126 but also with the first processing-liquid transferring unit 125. However, since the temperature was low, the amount of glycerin applied to the wiper 4 (consumption in each cycle of the wiping process) was only 0.02 mg. Therefore, 40% aqueous solution of glycerin, which was to be mainly used, was not affected.

The recording operation was performed at DUTY 25% by recording images on twenty A4-size sheets using four colors of ink, that is, cyan, magenta, yellow, and black ink while performing the wiping process once every time a single A4-size sheet was recorded on. The process was performed at the ambient temperature of 10 degrees Celsius and at the ambient temperature of 30 degrees Celsius. As a result, satisfactory recording results were obtained. In the present embodiment, the stopper 128 is provided to limit the moving range of the wiper. However, the moving range of the wiper can also be limited by other means, such as a motor, as long as the moving range of the wiper can be limited. Alternatively, instead of limiting the moving range of the wiper, the processing liquid can be prevented from being transferred to the wiper by covering the surface of the processing-liquid transferring unit that comes into contact with the wiper. Alternatively, as described above, the processing liquid can be prevented from being transferred to the wiper by stopping the supply of unnecessary processing liquid.

### Thirteenth Embodiment

A recovery unit according to a thirteenth embodiment includes two processing-liquid transferring units, and is configured such that the processing-liquid transferring units can be moved in accordance with the ambient temperature. More specifically, one of the processing-liquid transferring units that is not to be brought into contact with the wiper 4 is moved to a position where the wiper 4 does not comet into contact therewith. More specifically, the recovery unit according to the present embodiment is similar to the recovery unit 300B shown in FIG. 33 except the stopper 128 is omitted and the first and second processing-liquid transferring units 125 and 126 are configured such that one of the first and second processing-liquid transferring units 125 and 126 can be moved to a position where the wiper 4 does not come into contact therewith. The moving direction of the processing-liquid transferring units can be set to, for example, the Z direction in FIG. 33. The present embodiment differs from the twelfth embodiment in the above-described point. A recording head 1 of the present embodiment is similar to the recording head according to the first embodiment shown in FIG. 3.

### Fourteenth Embodiment

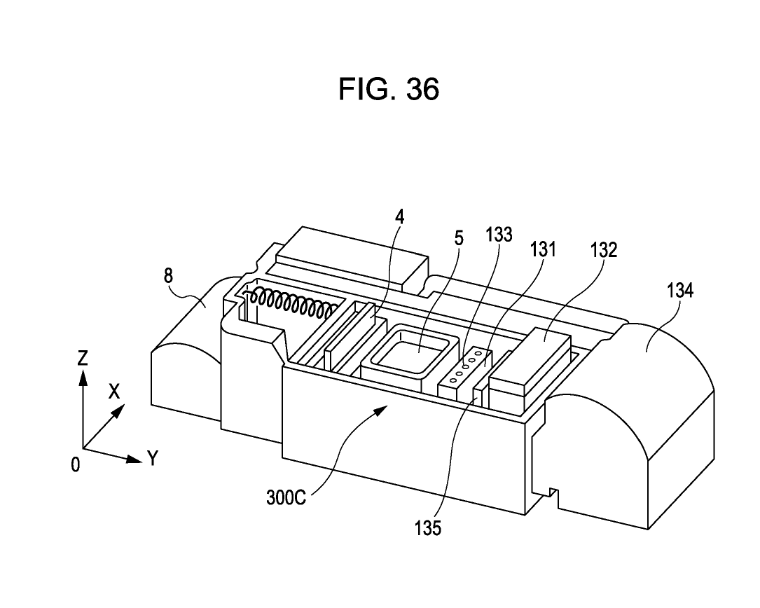

FIG. 36 is a perspective view of a recovery unit 300C included in an inkjet recording apparatus according to a fourteenth embodiment. Referring to FIG. 36, the recovery unit 300C includes a processing-liquid ejecting unit 131 and a processing-liquid transferring unit 132. Each of the processing-liquid ejecting unit 131 and the processing-liquid transferring unit 132 functions as a processing-liquid applying unit. When, for example, the ambient temperature is lower than a predetermined temperature, the processing liquid is ejected from ejection ports 133 of the processing-liquid ejecting unit 131 toward the discharge-port surface 2, so that the processing liquid adheres to the discharge-port surface 2. If the ambient temperature is higher than the predetermined temperature, the wiper 4 is brought into contact with the processing-liquid transferring unit 132 so that the processing liquid retained by the processing-liquid transferring unit 132 is transferred to the wiper 4. Different kinds of processing liquid are retained by the processing-liquid ejecting unit 131 and the processing-liquid transferring unit 132, and the discharge-port surface 2 is wiped using one of the two kinds of processing liquid in accordance with the temperature. The processing-liquid ejecting unit 131 and the processing-liquid transferring unit 132 receive the corresponding kinds of processing liquid from the processing-liquid container 134, which functions as a processing-liquid supplying unit.

The recovery unit 300C includes a stopper 135 that prevents the wiper 4 from coming into contact with the processing-liquid transferring unit 132 when the temperature is low. When the temperature is high, the recovery motor 8 stops driving the processing-liquid ejecting unit 131 so that the processing liquid is not ejected from the ejection ports 133 of the processing-liquid ejecting unit 131. Thus, the processing liquid transferred to the wiper 4 from the processing-liquid transferring unit 132 and the processing liquid applied to the discharge-port surface 2 from the processing-liquid ejecting unit 131 are selectively used in accordance with the temperature, and the wiping process is performed using the optimum kind of processing liquid in accordance with the temperature. An inkjet recording apparatus according to the present embodiment is similar to the inkjet recording apparatus shown in FIG. 31 except the recovery unit 300A is replaced by the recovery unit 300C shown in FIG. 36. A recording head 1 of the present embodiment is similar to the recording head according to the first embodiment shown in FIG. 3.

The above-described embodiments provide a wiping method for an inkjet recording head by which the discharge-port surface can be wiped using the optimum processing liquid for each of a discharge-port row at which ink adheres to the discharge-port surface at strong adhesion force and a discharge-port row at which ink adheres to the discharge-port surface at weak adhesion force. The optimum amount of processing liquid or the optimum kind of processing liquid is used in the process of wiping the discharge-port surface in accordance with the adhesion force of the ink discharged from each of the discharge-port rows. Therefore, the consumption of the processing liquid can be reduced. In addition, the wiping process can be performed with high efficiency, and therefore the throughput of the recording operation can be improved.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

1-7. (canceled)

8. An inkjet recording apparatus to record an image by discharging ink, the inkjet recording apparatus comprising:
a recording head having, at a discharge surface, a first discharge-port row configured to discharge a first ink having a first adhesion force and a second discharge-port row configured to discharge a second ink having a second adhesion force that is less than the first adhesion force;
a processing-liquid transferring unit configured to provide processing liquid, wherein the processing liquid is configured to remove ink components of ink on the discharge surface;
a wiper configured to wipe the discharge surface, wherein the wiper includes a first wiper segment positioned to wipe the first discharge-port row and a second wiper segment positioned to wipe the second discharge-port row; and
a control unit configured to move the wiper into and out of contact force engagement with the processing-liquid transferring unit, wherein the first wiper segment receives a quantity of processing liquid from the processing-liquid transferring unit that is greater than a quantity of processing liquid received by the second wiper segment from the processing-liquid transferring unit, whereby more processing liquid is applied from the first wiper segment to the first discharge-port row and any first ink having the first adhesion force than is applied from the second wiper segment to the second discharge-port row and any second ink having the second adhesion force, which is less than the first adhesion force.

9. The inkjet recording apparatus according to claim 8, wherein, due to moving the wiper into and out of contact force engagement with the processing-liquid transferring unit, a first contact force between the first wiper segment and the processing-liquid transferring unit is greater than a second contact force between the second wiper segment and the processing-liquid transferring unit such that the first wiper segment receives a quantity of processing liquid from the processing-liquid transferring unit that is greater than a quantity of processing liquid received by the second wiper segment from the processing-liquid transferring unit.

10. The inkjet recording apparatus according to claim 9, wherein the first contact force being greater than the second contact force is a result of the first wiper segment having a rigidity that is greater than a rigidity of the second wiper segment, wherein the first wiper segment and the second wiper segment each are positioned adjacent to at least one slit, and wherein the rigidity of the first wiper segment being greater than the rigidity of the second wiper segment is a result of a slit adjacent to the first wiper segment having a depth that is less than a depth of a slit adjacent to the second wiper segment.

11. The inkjet recording apparatus according to claim 9, wherein the wiper includes a slit that divides a portion of the wiper into the first wiper segment and the second wiper segment.

12. The inkjet recording apparatus according to claim 8, wherein the processing-liquid transferring unit is positioned remote from the discharge surface and configured to provide processing liquid that is different from the ink, wherein the processing liquid is configured to remove ink components by a dissolving action.

13. The inkjet recording apparatus according to claim 8, further comprising a container configured to store the processing liquid and provide the processing liquid to the processing-liquid transferring unit, wherein the processing liquid is different from the ink and configured to remove ink components by a dissolving action.

14. The inkjet recording apparatus according to claim 13, wherein the processing liquid contains glycerin.

15. The inkjet recording apparatus according to claim 8, wherein the wiper is configured to wipe the discharge surface to mix the processing liquid with ink on the discharge surface and remove the mixture from the discharge surface as waste to keep the discharge surface from becoming coated with dried ink and to keep the first discharge-port row and the second discharge-port row from becoming clogged.

16. The inkjet recording apparatus according to claim 8, wherein the first wiper segment includes a front surface and a rear surface and wherein the front surface and then the rear surface receive processing liquid from the processing-liquid transferring unit.

17. The inkjet recording apparatus according to claim 8, wherein the processing-liquid transferring unit is disposed at a certain position opposite to a standby position of the wiper across the recording head.

18. The inkjet recording apparatus according to claim 8, wherein the processing-liquid transferring unit includes a porous body capable of retaining the processing liquid.

19. A method for an inkjet recording apparatus to record an image by discharging ink, wherein the inkjet recording apparatus includes a recording head having, at a discharge surface, a first discharge-port row configured to discharge a first ink having a first adhesion force and a second discharge-port row configured to discharge a second ink having a second adhesion force that is less than the first adhesion force, a processing-liquid transferring unit configured to provide processing liquid, wherein the processing liquid is configured to remove ink components of ink on the discharge surface, and a wiper configured to wipe the discharge surface, wherein the wiper includes a first wiper segment positioned to wipe the first discharge-port row and a second wiper segment positioned to wipe the second discharge-port row, the method comprising:
moving the wiper into and out of contact force engagement with the processing-liquid transferring unit, wherein the first wiper segment receives a quantity of processing liquid from the processing-liquid transferring unit that is greater than a quantity of processing liquid received by the second wiper segment from the processing-liquid transferring unit, whereby more processing liquid is applied from the first wiper segment to the first discharge-port row and any first ink having the first adhesion force than is applied from the second wiper segment to the second discharge-port row and any second ink having the second adhesion force, which is less than the first adhesion force.

20. The method according to claim 19, wherein, due to moving the wiper into and out of contact force engagement with the processing-liquid transferring unit, a first contact force between the first wiper segment and the processing-liquid transferring unit is greater than a second contact force between the second wiper segment and the processing-liquid transferring unit such that the first wiper segment receives a quantity of processing liquid from the processing-liquid transferring unit that is greater than a quantity of processing liquid received by the second wiper segment from the processing-liquid transferring unit.

21. The method according to claim 20, the method further comprising bending the first wiper segment and bending the second wiper segment independent of the first wiper segment, wherein the first contact force being greater than the second contact force is a result of the first wiper segment having a rigidity that is greater than a rigidity of the second wiper segment, wherein the first wiper segment and the second wiper segment each are positioned adjacent to at least one slit, and wherein the rigidity of the first wiper segment being greater than the rigidity of the second wiper segment is a result of a slit adjacent to the first wiper segment having a depth that is less than a depth of a slit adjacent to the second wiper segment.

22. The method according to claim 20, the method further comprising bending the first wiper segment and bending the second wiper segment independent of the first wiper segment, wherein the wiper includes a slit that divides a portion of the wiper into the first wiper segment and the second wiper segment.

23. The method according to claim 19, wherein the processing-liquid transferring unit is positioned remote from the discharge surface, the method further comprising providing processing liquid that is different from the ink, wherein the processing liquid is configured to remove ink components by a dissolving action.

24. The method according to claim 19, the method further comprising:
receiving a processing liquid that contains glycerin into a container; and
providing the processing liquid to the processing-liquid transferring unit from the container, wherein the processing liquid is different from the ink and configured to remove ink components by a dissolving action.

25. The method according to claim 19, further comprising wiping the discharge surface with the wiper to mix the processing liquid with ink on the discharge surface and remove the mixture from the discharge surface as waste to keep the discharge surface from becoming coated with dried ink and to keep the first discharge-port row and the second discharge-port row from becoming clogged.

26. The method according to claim 19, wherein the first wiper segment includes a front surface and a rear surface, the method further comprising receiving processing liquid on the front surface and then the rear surface from the processing-liquid transferring unit.

27. The method according to claim 19, wherein the processing-liquid transferring unit is disposed at a certain position opposite to a standby position of the wiper across the recording head, the method further comprising:
retaining the processing liquid in a porous body of the processing-liquid transferring unit; and
moving the wiper from the standby position to the processing-liquid transferring unit.
